(19) United States
(12) Patent Application Publication
(10) Pub. No.: US 2025/0056278 A1
(43) Pub. Date: Feb. 13, 2025

(54) CSI REPORTING RULES FOR SPATIAL AND POWER ADAPTATION

(71) Applicant: QUALCOMM Incorporated, San Diego, CA (US)

(72) Inventor: Hung Dinh LY, San Diego, CA (US)

(21) Appl. No.: 18/447,710

(22) Filed: Aug. 10, 2023

(51) Int. Cl. H04W 24/10; H04L 5/00; H04W 72/21

(52) U.S. Cl. CPC H04W 24/10; H04L 5/0051; H04W 72/21

(57) ABSTRACT

A method for wireless communication at a user equipment (UE) and related apparatus are provided. In the method, the UE receives, from a network entity, a channel state information (CSI) report configuration including a set of sub-configurations. Each sub-configuration in the set of sub-configurations corresponds to a transmission setting associated with a channel state information reference signal (CSI-RS). The UE further determines one or more selected CSIs corresponding to a subset of the set of sub-configurations, incorporates the one or more selected CSIs into one or more CSI reports, and transmits, to the network entity, the one or more CSI reports based on the incorporation.

### TECHNICAL FIELD

The present disclosure relates generally to communication systems, and more particularly, to channel state information (CSI) reporting rules for spatial and power adaptation for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to receive, from a network entity, a CSI report configuration including a set of sub-configurations. Each sub-configuration in the set of sub-configurations may correspond to a transmission setting associated with a channel state information reference signal (CSI-RS). The at least one processor, individually or in any combination, may be further configured to determine one or more selected CSIs corresponding to a subset of the set of sub-configurations; incorporate the one or more selected CSIs into one or more CSI reports; and transmit, to the network entity, the one or more CSI reports based on the incorporation.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to transmit, to a UE, a CSI report configuration including a set of sub-configurations. Each sub-configuration in the set of sub-configurations may correspond to a transmission setting associated with a CSI-RS. The at least one processor, individually or in any combination, may be further configured to receive, from the UE, a CSI report. The CSI report may include one or more selected CSIs corresponding to a subset of the set of sub-configurations.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example two-step implementation of spatial element adaptation.

FIG. 5A is a diagram illustrating an example Type 1 spatial domain (SD) adaptation.

FIG. 5B is a diagram illustrating an example Type 2 SD adaptation.

FIG. 6 is a diagram illustrating an example two-step implementation of power offset values adaptation.

FIG. 7A is a diagram illustrating an example of concatenating Part 1 CSIs of CSIs associated with multiple sub-configurations in accordance with various aspects of the present disclosure.

FIG. 7B is a diagram illustrating an example of multiplexing Part 1 CSIs of CSIs associated with multiple sub-configurations in accordance with various aspects of the present disclosure.

FIG. 8A is a diagram illustrating an example transmission of multiple CSI reports using uplink control information (UCI) bit sequences.

FIG. 8B is a diagram illustrating an example transmission of multiple CSIs with sub-configurations in accordance with various aspects of the present disclosure.

FIG. 8C is a diagram illustrating an example transmission of multiple CSIs with sub-configurations in accordance with various aspects of the present disclosure.

FIG. 9 is a call flow diagram illustrating a method of wireless communication in accordance with various aspects of the present disclosure.

FIG. 10 is a flowchart illustrating methods of wireless communication at a UE in accordance with various aspects of the present disclosure.

FIG. 11 is a flowchart illustrating methods of wireless communication at a UE in accordance with various aspects of the present disclosure.

FIG. 12 is a flowchart illustrating methods of wireless communication at a network entity in accordance with various aspects of the present disclosure.

FIG. 13 is a flowchart illustrating methods of wireless communication at a network entity in accordance with various aspects of the present disclosure.

FIG. 14 is a diagram illustrating an example of a hardware implementation for an example apparatus and/or network entity.

FIG. 15 is a diagram illustrating an example of a hardware implementation for an example network entity.

### DETAILED DESCRIPTION

The CSI provides information for efficient resource allocation and optimized network performance. As the network complexity increases with the development of diverse services, applications, and devices, a CSI report may include CSIs associated with multiple sub-configurations. Handling CSI with multiple sub-configurations can be a complex task, with varying degrees of efficiency and effectiveness in different scenarios. Example aspects provided herein present methods and apparatus for CSI reporting rules for spatial and power adaptation associated with multiple sub-configurations.

Various aspects relate generally to wireless communication. Some aspects more specifically relate to CSI reporting rules for spatial and power adaptation for wireless communication. In some examples, a UE may receive, from a network entity, a CSI report configuration including a set of sub-configurations, where each sub-configuration in the set of sub-configurations may correspond to a transmission setting associated with a CSI-RS; determine one or more selected CSIs corresponding to a subset of the set of sub-configurations; incorporate the one or more selected CSIs into one or more CSI reports; and transmit, to the network entity, the one or more CSI reports based on the incorporation. In some aspects, the UE may jointly encode the one or more selected CSIs corresponding to the subset of the set of sub-configurations. In some aspects, the UE may encode the first parts of the one or more selected CSIs corresponding to the subset of the set of sub-configurations separately to obtain the encoded first parts of the one or more selected CSIs corresponding to the subset of the set of sub-configurations.

Particular aspects of the subject matter described in this disclosure can be implemented to realize one or more of the following potential advantages. In some examples, by providing flexible methods to manage multiple CSIs from multiple sub-configurations, the described techniques optimize the CSI reporting process, leading to improved efficiency in terms of encoding and CSI management. In some aspects, by allowing the UEs to have various options to handle multiple CSIs corresponding to the sub-configurations, such as concatenation, multiplexing, or treating each CSI as a separate report, and by allowing the UEs to prioritize the CSI reports based on the number of CSIs and sub-configurations, the described techniques improve the efficiency of wireless communication.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well-known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically crasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (NB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

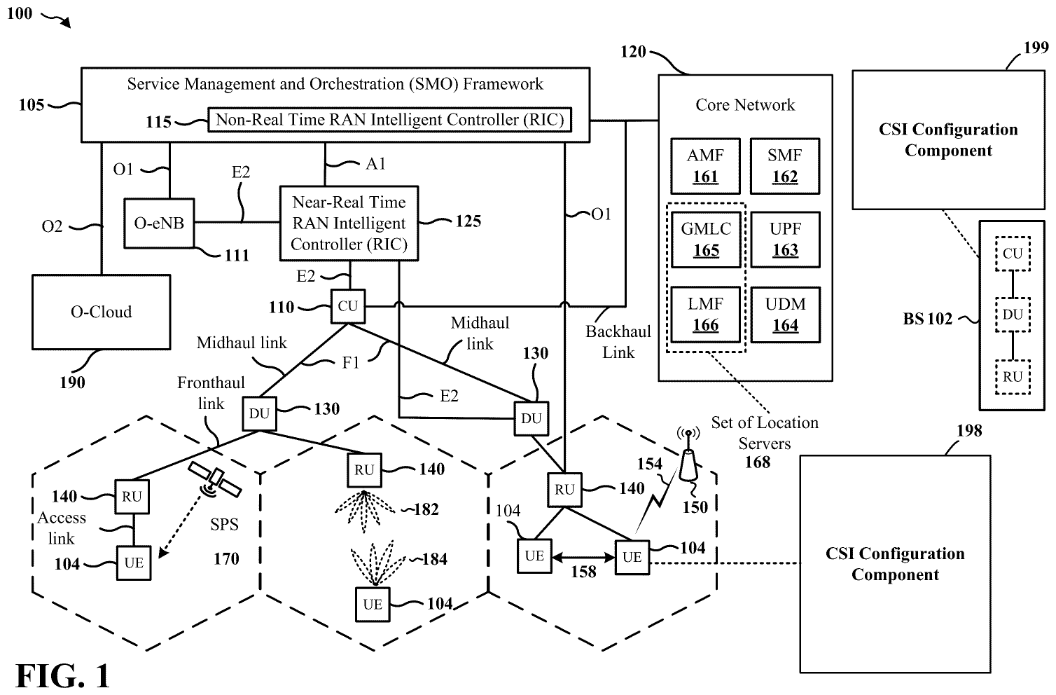

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHZ (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell). Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ).

Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHZ-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2. FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a CSI configuration component 198. The CSI configuration component 198 may be configured to receive, from a network entity, a CSI report configuration including a set of sub-configurations, where each sub-configuration in the set of sub-configurations corresponds to a transmission setting associated with a CSI-RS; determine one or more selected CSIs corresponding to a subset of the set of sub-configurations; incorporate the one or more selected CSIs into one or more CSI reports; and transmit, to the network entity, the one or more CSI reports based on the incorporation. In certain aspects, the base station 102 may include a CSI configuration component 199. The CSI configuration component 199 may be configured to transmit, to a UE, a CSI report configuration including a set of sub-configurations, where each sub-configuration in the set of sub-configurations corresponds to a transmission setting associated with a CSI-RS; and receive, from the UE, a CSI report. The CSI report may include one or more selected CSIs corresponding to a subset of the set of sub-configurations. Although the following description may be focused on 5G NR, the concepts described herein may be applicable to other similar areas, such as LTE, LTE-A, CDMA, GSM, and other wireless technologies.

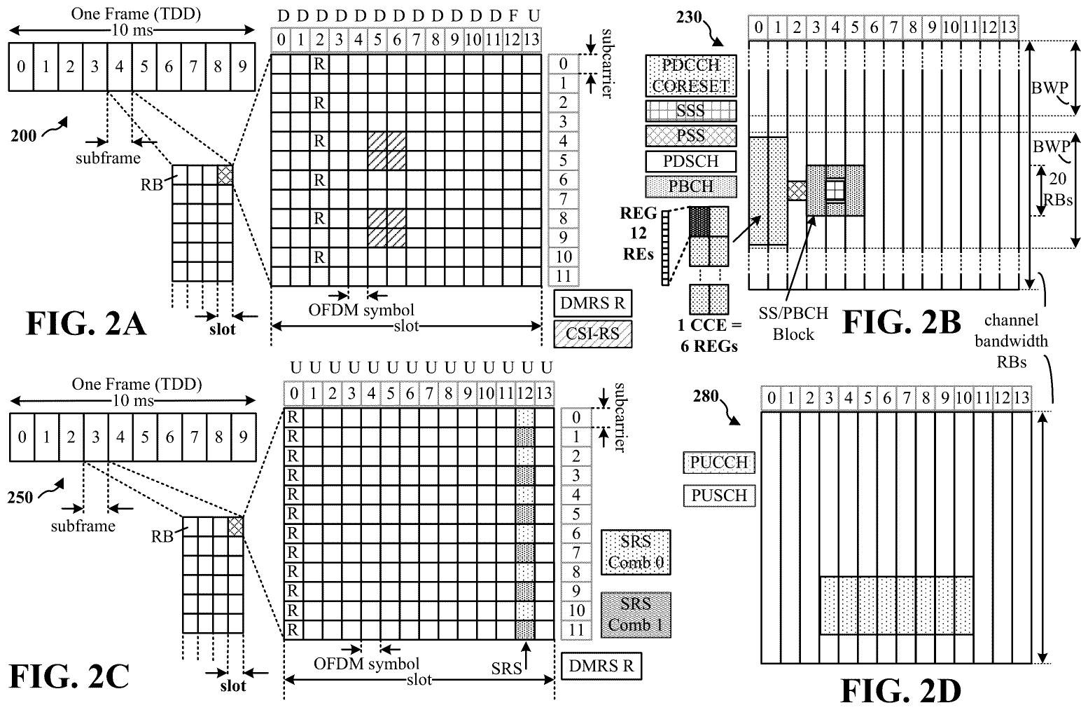

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| | Δf = 2μ · 15 | Cyclic |
| μ | [kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

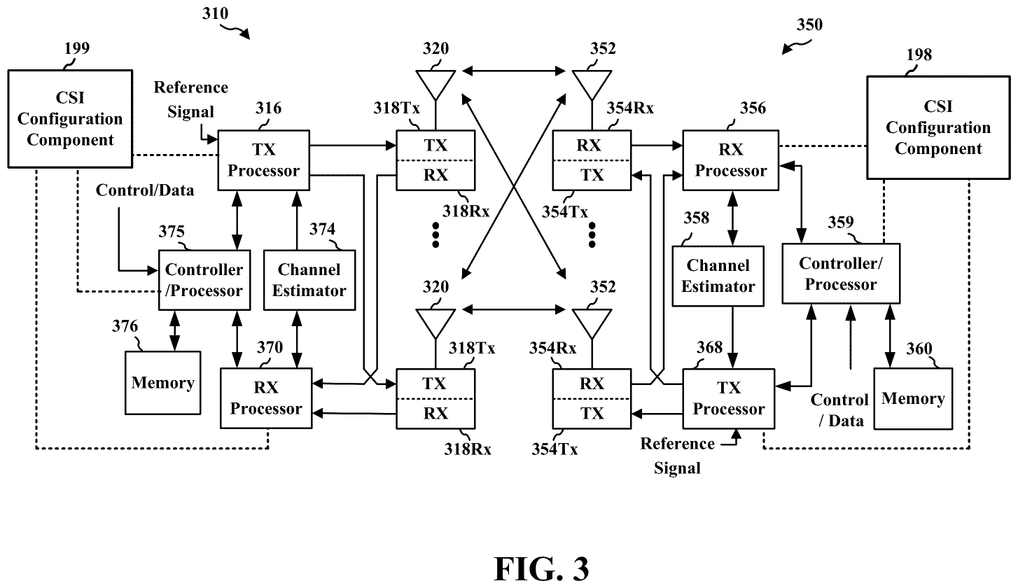

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging. RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB. SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the CSI configuration component 198 of FIG. 1.

At least one of the TX processor 316, the RX processor 370, and the controller/processor 375 may be configured to perform aspects in connection with the CSI configuration component 199 of FIG. 1.

Example aspects of the present disclosure provide methods and apparatus related to the rules for ordering and concatenation of CSI report Part 1 and Part 2 when the UE reports multiple sub-configurations.

Massive multiple-input multiple-output (MIMO) technology is one of the fundamental technologies in 5G NR for high spectral efficiency and extended coverage. For downlink transmissions, massive MIMO may be equipped with a large number of transceiver chains (e.g., 64 chains in FR1 are typically deployed in commercial 5G networks, especially at the carrier frequency of 3.5 GHz or higher). Each transceiver chain may be connected to one or more power amplifiers. However, the power amplifiers connected to these transceiver chains may consume approximately 70%-80% of base station (BS) power.

To reduce BS power consumption, a cell may turn on/off one or more power amplifiers, or equivalently, transceiver chains, depending on the time/frequency resource utilization within the cell. This on/off adaptation scheme, while feasible under current standards, may be further improved as being standardized. The focus is on necessary enhancements on CSI and beam management to enable more efficient adaptation of spatial elements.

Two types of spatial domain (SD) adaptations may be utilized. The first, Type 1 SD adaptation, adapts the configuration of logical antenna ports for CSI-reference signals (CSI-RS) and/or PDSCH. The second, Type 2 SD adaptation, adapts the configuration of physical antenna elements for CSI-RS and/or PDSCH. The latter type is particularly useful for FR2 where the number of transmit receive units (TxRUs) at the base station is limited (typically to 1 or 2). The number of logical antenna ports may remain unchanged while the number of physical antenna elements can be adapted, thereby impacting the beamforming gain.

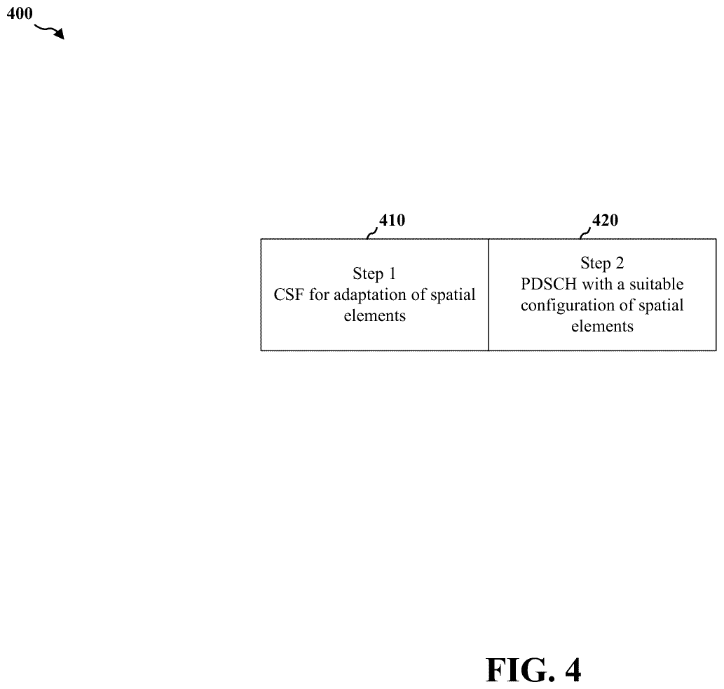

Various enhancements to the CSI framework may be utilized to support the SD adaptation. FIG. 4 is a diagram 400 illustrating an example two-step implementation of spatial element adaptation. In FIG. 4, the first step 410 (Step 1) may involve CSI feedback (CSF) for the adaptation of spatial elements. In this step, the base station may configure a CSI report configuration with multiple sub-configurations, each corresponding to a CSI-RS antenna port configuration. The UE may measure and report CSI associated with all or a subset of sub-configurations based on network indication, which may indicate to the UE which subset of sub-configurations to measure and report. In the second step 420 (Step 2), the base station may switch among different configurations of active spatial elements (for PDSCH transmission) based on the CSI reports received from the UE.

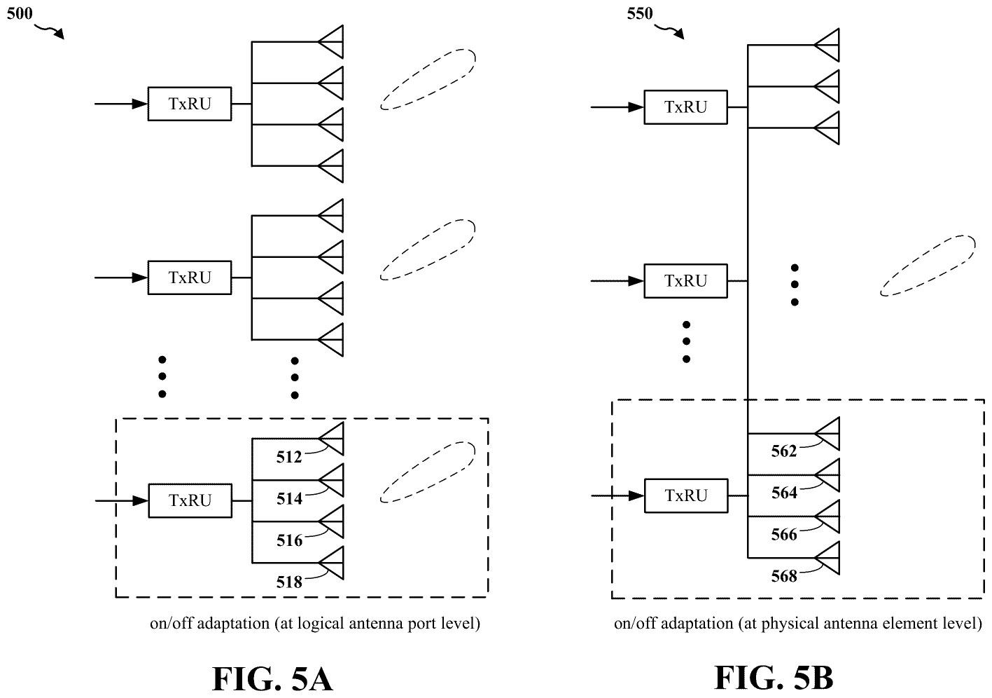

FIG. 5A is a diagram 500 illustrating an example Type 1 SD adaptation. In FIG. 5A, the configuration of logical antenna ports for CSI-RS and/or PDSCH may be adapted. As an example, the configuration of logical antenna ports may be the configuration for logical antenna ports 512, 514, 516, and 518. FIG. 5B is a diagram 550 illustrating an example Type 2 SD adaptation configuration of physical antenna ports for CSI-RS and/or PDSCH may be adapted. As an example, the configuration of physical antenna ports may be the configuration for physical antenna ports 562, 564, 566, and 568. Dynamic adaptation of the power offset values between PDSCH and CSI-RS may be beneficial for network energy savings. Hence, the enhancements on CSI may lead to efficient adaptation of power offset values between PDSCH and CSI-RS. Through the adaptation of the power offset values, the base station may be capable of compensating for some measurements (e.g., layer 1-reference signal received power (L1-RSRP) and channel quality indicator (CQI)) based on the transmission power difference between the actual power offset and the configured power offset that the UE uses for the CSI report. This compensation mechanism is compatible with existing standards, especially when the transmission power difference is not substantial. However, when the transmission power difference is large, the compensation at the base station may not be accurately applied to parameters such as rank indicator (RI) and/or precoding matrix indicator (PMI).

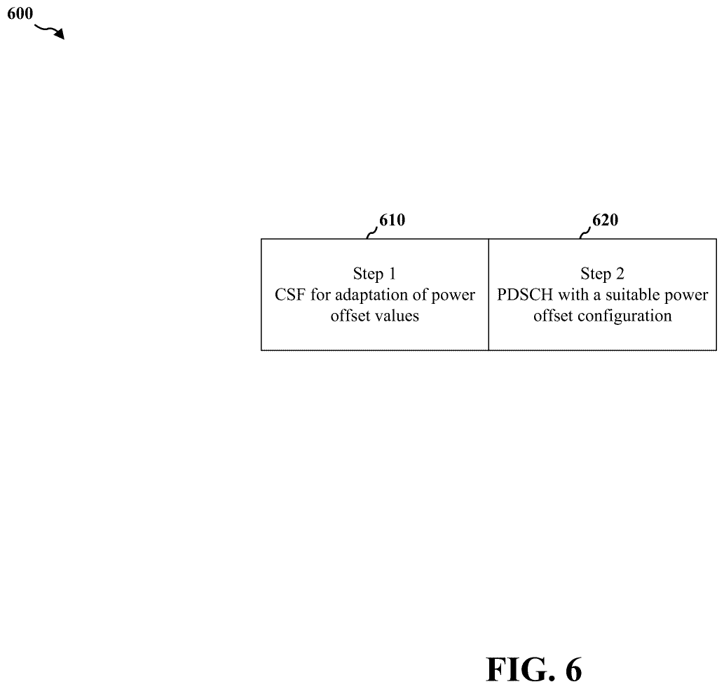

To accomplish dynamic adaptation of the power offset values between PDSCH and CSI-RS, a two-step procedure may be used. FIG. 6 is a diagram 600 illustrating an example two-step implementation of power offset values adaptation. As shown in FIG. 6, the first step 610 (Step 1) may involve CSF for the adaptation of power offset values. The second step 620 (Step 2) may include the transmission of PDSCH with a suitable power offset configuration. The CSI framework for power domain (PD) adaptation may be similar to that of SD adaptation. However, the distinction lies in defining the sub-configuration. For PD adaptation, the sub-configuration may contain the power offset value between PDSCH and CSI-RS.

Example aspects presented herein may provide methods and apparatus for mapping multiple CSIs in a CSI report. In some aspects, at a high level, the implementation of the CSI report may include three main steps.

In the first step, CSI may be generated for each sub-configuration. In some examples, CSI may include Part 1 CSI, or both Part 1 CSI and Part 2 CSI, which may be separately encoded. All CSIs for sub-configurations may have either Part 1 CSI, or both Part 1 CSI and Part 2 CSI. The second step may involve concatenation or multiplexing of CSIs associated with multiple sub-configurations. This step may further include the implementation of multiplexing CSI parts across sub-configurations when CSI includes both Part 1 and Part 2, and the order of CSI concatenation across sub-configurations.

The third step may include performing CSI drop or omission if the CSI report code rate is less than or equal to the one configured by the higher layer parameter (e.g., maxCodeRate). As used herein, the term “CSI drop (or omission)” may refer to the scenario where the UE decides not to send a CSI report or a portion of CSI report to the base station even though it is expected to do so periodically. In some examples, the rules for CSI drop or omission may allow for either a portion of Part 2 CSI or a portion of the CSI report to be omitted based on the priority orders provided. For example, if any of the CSI reports consist of two parts, the UE may omit a portion of Part 2 CSI. The omission of Part 2 CSI may follow a priority order. The UE may start omitting Part 2 CSI beginning with the lowest priority level, continuing until the Part 2 CSI code rate is less than or equal to the code rate configured by the higher layer parameter (e.g., maxCodeRate). For example, if CSI reports consist of one part, the UE may omit a portion of these CSI reports. The omission of CSI reports may be determined by their priority order, which may be determined based on, for example, parameter Pri_{i,CSI} (y, k, c, s), which may be calculated as:

$${Pri}_{i , CSI} ( y , k , c , s ) = 2 \cdot {N}_{cells} \cdot {M}_{s} \cdot y + {N}_{cells} \cdot {M}_{s} \cdot k + {M}_{s} \cdot c + s \qquad ( 1 )$$

In Equation (1), y represents the type of CSI report. For example, y=0 represents aperiodic CSI (A-CSI) reports to be carried on PUSCH, y=1 represents semi-persistent CSI (SP-CSI) reports to be carried on PUSCH, y=2 represents SP-CSI reports to be carried on PUCCH, and y=3 represents periodic CSI (P-CSI) reports to be carried on PUCCH. k corresponds to CSI reports carrying L1-RSRP or L1-SINR (k=0), or those that do not carry L1-RSRP or L1-SINR (k=1). c is the serving cell index, while N_{cells} is the value of the higher layer parameter maxNrofServingCells. s is the reportConfigID, and Ms is the value of the higher layer parameter maxNrofCSI-ReportConfigurations.

The UE may omit CSI reports starting from the lowest priority level and proceed until the CSI report code rate is less than or equal to the code rate configured by the higher layer parameter (e.g., maxCodeRate).

Example aspects presented herein pertain to methods and apparatus for a CSI report containing CSIs for N sub-configurations associated with a CSI report configuration that includes a larger number (e.g., L. 1≤N≤L) of sub-configurations. In some aspects, the CSI report may have an associated priority compared to other CSI reports that lack configured sub-configuration, and CSI drop or omission may be performed within the CSI report that includes CSIs for N sub-configurations.

In some examples, for Type I, Type II, Enhanced Type II, and Further Enhanced Type II Port Selection CSI feedback on PUSCH, a CSI report may include two parts, referred to as Part 1 and Part 2 of the CSI report, respectively. Part 1 may have a fixed payload size and may be used to identify the number of information bits in Part 2. Part 1 may be transmitted in its entirety before Part 2.

For Type I CSI feedback, Part 1 may include RI (if reported), the channel reference indicator (CRI, if reported), and CQI for the first codeword (if reported). Part 2 may include the PMI (if reported), the layer indicator (LI, if reported), and the CQI for the second codeword when, for example, the RI is more than 4. For example, for a CSI-ReportConfig configured with codebookType set to “typel-SinglePanel” and the corresponding CSI-RS resource set for channel measurement configured with two resource groups and N resource pairs, Part 1 may contain RI(s), CRI(s), CQI(s) for the first codeword and may be zero-padded to a fixed payload size. Part 2 may contain the CQI(s) for the second codeword (if reported) when RI is larger than 4, LIs (if reported), and PMI(s).

For Type II CSI feedback, Part 1 may include the RI (if provided), the CQI, and an indication of the number of non-zero wideband amplitude coefficients per layer for Type II CSI. Each field in Part 1 (e.g., the RI (if provided), CQI, and the indication for the count of non-zero wideband amplitude coefficients per layer) may be encoded separately. Part 2 may include the PMI and LI (if provided) for Type II CSI. The elements of i_{1,4,l}, i_{2,4,l} (if reported) and i_{2,2,l} (if reported) may be reported in ascending order of their indices, i=0, 1, . . . , 2L−1, where the element with the lowest index may be mapped to the most significant bits and the element with the highest index may be mapped to the least significant bits. Both Part 1 and 2 may be encoded separately.

For Enhanced Type II CSI feedback and Further Enhanced Type II port selection CSI feedback, Part 1 may include the RI (if reported), the CQI, and an indication of the overall number of non-zero amplitude coefficients across layers. Each field in Part 1 (e.g., the RI (if reported), CQI, and the indication of the overall number of non-zero amplitude coefficients across layers) may be encoded separately. Part 2 may include the PMI for the Enhanced Type II or Further Enhanced Type II Port Selection CSI. Both Part 1 and 2 may be encoded separately.

In some aspects, when two overlapping PUSCHs occur, each CSI report may be associated with a priority value, denoted as Pri_{i,CSI} (y, k, c, s), and may be calculated according to Equation (1). A CSI report may be considered to have priority over a second CSI report if its associated priority value (e.g., Pri_{i,CSI} (y, k, c, s)) is lower than that of the second CSI report. If y values are different between the two CSI reports, the CSI report with a higher priority value (e.g., Pri_{i,CSI} (y, k, c, s)) may not be sent by the UE. The exception is when one y value is 2 and the other is 3 (e.g., for CSI reports transmitted on PUSCH or CSI reports transmitted on PUCCH). If the y values are the same, the two CSI reports may be either multiplexed or one is dropped, depending on the priority values.

Example aspects provide methods and apparatus for concatenating or multiplexing the CSI from multiple sub-configurations. In some examples, when CSI has Part 1 CSI and Part 2 CSI, and when a UE is configured with a CSI report containing a set of sub-configurations (e.g., L sub-configurations) and the UE reports CSIs for a subset of sub-configurations (e.g., N sub-configuration, with 1≤N≤L) among the set of sub-configurations (e.g., L sub-configurations), the UE can choose between two options for CSI reporting.

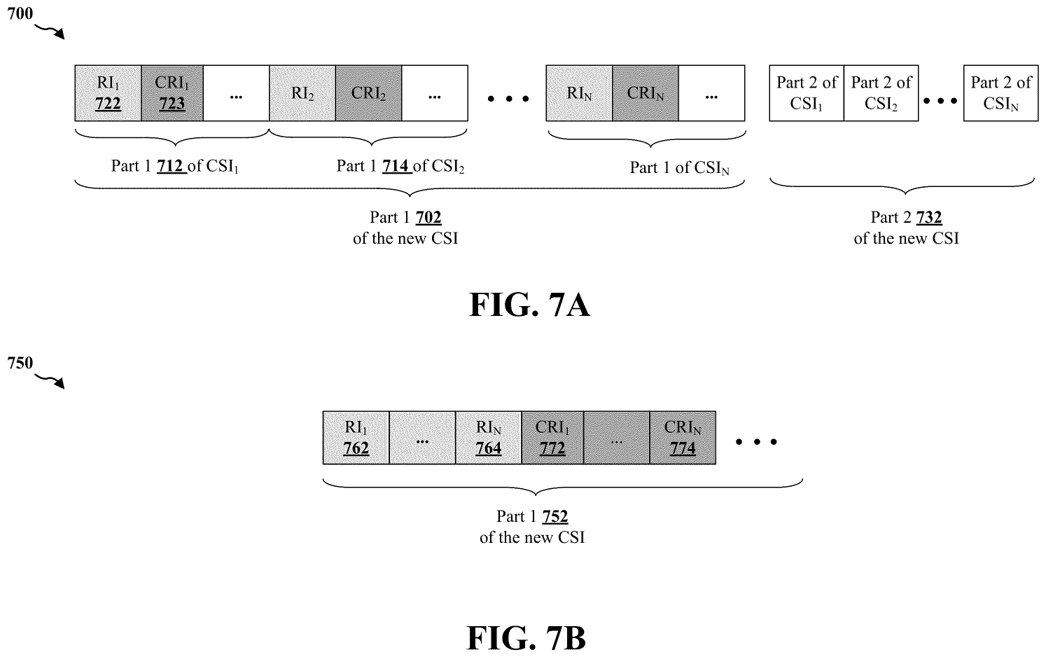

In the first option, the UE may concatenate or multiplexes Part 1 CSI of the CSIs associated with N sub-configurations to form a new Part 1 CSI. FIG. 7A is a diagram 700 illustrating an example of concatenating Part 1 CSIs of CSIs associated with multiple sub-configurations in accordance with various aspects of the present disclosure. As shown in FIG. 7A, the new Part 1 702 CSI may be obtained by concatenating Part 1 712 of the CSI associated with sub-configuration 1 (e.g., CSI₁), Part 1 714 of the CSI associated with sub-configuration 2 (e.g., CSI₂), until Part 1 of the CSI associated with the sub-configuration N (e.g., CSI_{N}). As an example, Part 1 of CSI associated with a sub-configuration may include RI (e.g., RI₁ 722), CRI (e.g., CRI₁ 723), etc. A similar implementation can be applied to Part 2 of the new CSI. For example, as shown in FIG. 7A, Part 2 732 of the new CSI may be obtained by concatenating Part 2 of the CSI₁, Part 2 of CSI₂, etc.

FIG. 7B is a diagram 750 illustrating an example of multiplexing Part 1 CSIs of CSIs associated with multiple sub-configurations in accordance with various aspects of the present disclosure. As shown in FIG. 7B, the new Part 1 752 CSI may be obtained by multiplexing Part 1 CSIs of the CSIs associated with N sub-configuration 1 (e.g., CSI₁, CSI₂, . . . ). For example, Part 1 752 CSI of the new CSI may sequentially include RIs from Part 1 CSIs of the CSIs associated with N sub-configurations (e.g., RI₁ 762, . . . , RI_{N} 764), CRIs from Part 1 CSIs of the CSIs associated with N sub-configurations (e.g., CRI₁ 772, . . . , CRI_{N} 774), etc. A similar implementation can be applied to Part 2 of the new CSI. For example, Part 2 of the new CSI may be obtained by multiplexing Part 2 of the CSI₁, Part 2 of CSI₂, etc.

As used herein, the term “concatenating” or “concatenation” refers to the process of linking or combining several individual parts together, without any alternations to the individual parts, to form a single, larger entity. On the other hand, the term “multiplexing” refers to the process of merging multiple individual parts into a single, larger entity, and the components of the individual parts may be combined during this process. For example, in FIG. 7B, when multiplexing CSIs associated with the sub-configurations (e.g., CSI₁, CSI₂, . . . ), the components of the CSIs, such as RIs (e.g., RIs 762, . . . , 764) and CRIs (e.g., CRIs, 772, . . . , 774) may be combined together. In the first option, Part 1 CSIs of CSIs associated with N sub-configurations may be jointly encoded, allowing for easy control over the code rate for CSI Part 1. Similar considerations may be applied to Part 2 CSIs of CSIs associated with N sub-configurations. As used herein, “jointly encoded” refers to the process of encoding multiple CSI reports together as a single entity, instead of encoding each CSI report independently. Hence, “Part 1 CSIs of CSIs associated with N sub-configurations may be jointly encoded” means Part 1 of N CSI reports is considered a group and encoded as a whole.

In the second option, the UE may treat the CSI for each sub-configuration as a separate CSI report. In this approach, the Part 1 and Part 2 CSIs are encoded separately, then multiplexed. While this option necessitates a minimal change to UE implementation, it generates more encoding operations and makes it more challenging to control the code rate for a given CSI part. In some examples, the CSIs associated with N sub-configurations may be concatenated. Alternatively, in other examples, the CSIs associated with N sub-configurations may be multiplexed at the CSI part level. For example, the multiple CSI reports may be transmitted via uplink control information (UCI) bit sequences. For a CSI report configuration that includes N sub-configurations, a part of the first UCI bit sequence may include Part 1 CSI of each sub-configuration, arranged as follows: [Part 1 CSI of the CSI associated with sub-configuration 1, Part 1 CSI of the CSI associated with sub-configuration 2, . . . , Part 1 CSI of the CSI associated with sub-configuration N]. Similarly, a part of the second UCI bit sequence may include Part 2 CSI of each sub-configuration, arranged as follows: [Part 2 CSI of the CSI associated with sub-configuration 1, Part 2 CSI of the CSI associated with sub-configuration 2, . . . , Part 2 CSI of the CSI associated with sub-configuration N].

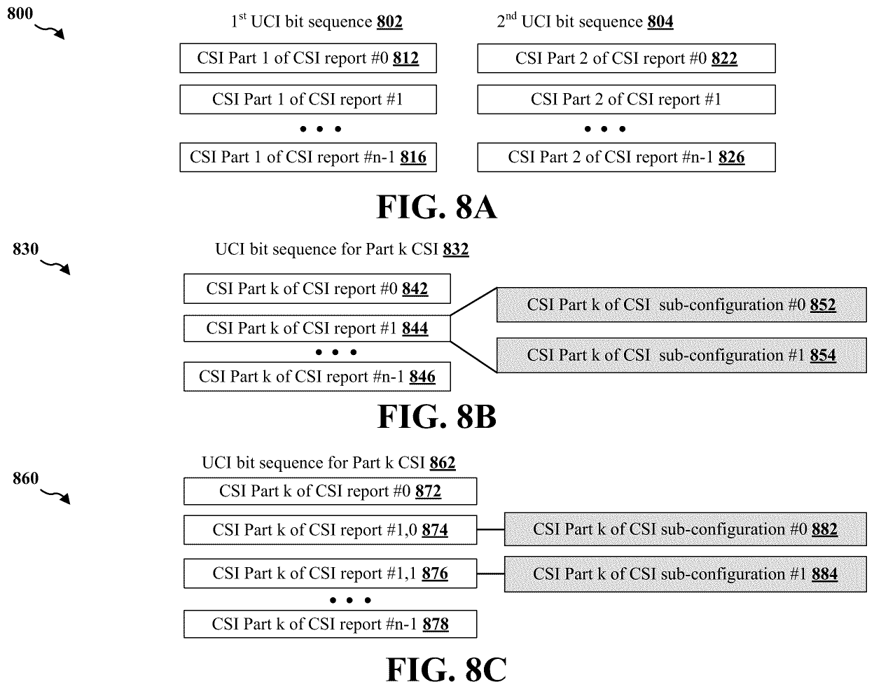

FIG. 8A is a diagram 800 illustrating an example transmission of multiple CSI reports using UCI bit sequences. In FIG. 8A, the multiple CSI reports may be transmitted via UCI bit sequences. For example, the first UCI bit sequence 802 may include CSI Part 1 for different CSI reports, starting from CSI report #0 812 to CSI report #n−1 816, where n is the total number of CSI reports in the first UCI bit sequence 802. The second UCI bit sequence 804 may include CSI Part 2 for different CSI reports, starting from CSI report #0 822 to CSI report #n−1 826.

FIG. 8B is a diagram 830 illustrating an example transmission of multiple CSIs with sub-configurations in accordance with various aspects of the present disclosure. In FIG. 8B, each UCI bit sequence for Part k (where k may be 1 or 2, for example) of the CSI 832 may include Part k from multiple CSI reports, starting from CSI report #0 842, to CSI report #n−1 846. If one of the CSI reports (e.g., the CSI report #1 844) is configured with multiple sub-configurations, the CSI Part k of CSI report #1 844 may include the CSI Part k of the CSI for one or more sub-configurations. For example, as shown in FIG. 8B, the CSI Part k of CSI report #1 844 may include the CSI Part k of the CSI for sub-configuration #0 852 and the CSI Part k of the CSI for sub-configuration #1 854.

FIG. 8C is a diagram 860 illustrating an example transmission of multiple CSIs with sub-configurations in accordance with various aspects of the present disclosure. In FIG. 8C, the CSI for each sub-configuration is treated as if it were an individual CSI report. For example, assuming the CSIs of two sub-configurations are reported, the UCI bit sequence for Part k (where k may be 1 or 2, for example) CSI 862 may include Part k from multiple CSI reports. For example, the UCI bit sequence for Part k CSI 862 may include CSI Part k of CSI report #0 872, CSI Part k of CSI report #1,0 874, CSI Part k of CSI report #1,1 876, and so on up to the CSI Part k of CSI report #n−1 878. Among the Part k from multiple CSI reports, the CSI Part k of CSI report #1,0 874 may correspond to CSI Part k of CSI for sub-configuration #0 882, and the CSI Part k of CSI report #1,1 874 may correspond to CSI Part k of CSI for sub-configuration #1 884.

In some aspects, when a UE is configured with a CSI report configuration containing L sub-configurations, and the UE reports CSIs for N sub-configurations (1≤N≤L), The order of CSI concatenation/multiplexing across sub-configurations may follow several steps based on the type of CSI reporting involved.

For aperiodic CSI (A-CSI) reporting or semi-persistent CSI (SP-CSI) reporting on PUSCH, the UE may map CSIs for N sub-configurations indicated for CSI measurement and reporting according to the order of sub-configurations indicated in the triggering state requested by DCI. A list of N sub-configurations, from a total of L sub-configurations in the CSI report configuration, may be indicated as part of the triggering state that is requested by DCI for CSI measurement and reporting.

For semi-persistent CSI (SP-CSI) reporting on PUCCH, the UE may map the CSIs for N sub-configurations indicated for CSI measurement and reporting according to the order of the sub-configurations indicated in the medium access control (MAC)-control element (MAC-CE) during the SP-CSI activation/deactivation. Here, a list of N sub-configurations from a total of L sub-configurations in the CSI report configuration may be indicated as part of the SP-CSI activation/deactivation MAC-CE for CSI measurement and reporting.

For periodic CSI (P-CSI) reporting, the UE may map CSIs for N sub-configurations indicated for CSI measurement and reporting in the order of the sub-configurations configured in the CSI report configuration. For P-CSI reporting, N is always equal to L.

In some examples, the mapping order may start from either the first or last indicated sub-configuration index, progressing to the last or first indicated sub-configuration index, respectively.

For example, consider a CSI report configuration for an A-CSI reporting that has four sub-configurations. The DCI trigger state activated by DCI may have the following information (meaning sub-configurations 1/2/3 for AssociatedReportConfigID1):

$$CSI - AperiodicTriggerState 1 \{ associatedReportConfigInfoList = \{ AssociatedReportConfigID 1 \} associatedSubConfig = \{ 2 - 3 - 1 \} \} \qquad ( 2 )$$

If the order for concatenation/multiplexing is from the first indicated sub-configuration index to the last indicated sub-configuration index, the CSI associated with sub-configuration 2 is considered first, followed by the CSI associated with sub-configuration 3, and then finally, the CSI associated with sub-configuration 1.

In some aspects, a CSI report may have an associated priority when compared with another CSI report associated with a CSI report configuration without sub-configuration (which may be referred to as, for example, a legacy CSI report configuration).

In some aspects, for the same CSI reporting type (e.g., P-CSI, SP-CSI, or A-CSI), various rules may apply when determining the priority of the CSI report.

In one configuration, a CSI report with more than one CSI (N>1) associated with a CSI report configuration that contains more than one sub-configuration (L>1) may have the same priority as a CSI report that has one CSI (N=1) associated with a CSI report configuration that contains more than one sub-configuration (L>1) or a legacy CSI report.

In one configuration, a CSI report with more than one CSI (N>1) associated with a CSI report configuration that contains more than one sub-configuration (L>1) may have a higher priority than a CSI report that has one CSI (N=1) associated with a CSI report configuration that contains more than one sub-configuration (L>1) or a legacy CSI report.

In one configuration, a CSI report with more than one CSI (N>1) associated with a CSI report configuration that contains more than one sub-configuration (L>1) may have a lower priority than a CSI report that has one CSI (N=1) associated with a CSI report configuration that contains more than one sub-configuration (L>1) or a legacy CSI report.

In some examples, a legacy CSI report may not have a defined sub-configuration and may have one CSI to report. However, for the non-coherent joint transmission (NCJT) CSI in mTRP, multiple CSIs may be reported within a single report.

In some aspects, when a UE is configured with a CSI report configuration that contains multiple (e.g., L) sub-configurations, and the UE is reporting CSIs for a subset (e.g., N, 1<N≤L) of these sub-configurations, the prioritization of dropping either Part 1 or Part 2 CSIs may be based on the order of sub-configurations as indicated to the UE for CSI measurement and reporting. For example, the prioritization of dropping may be based on the order of sub-configurations indicated in the triggering state requested by DCI for A-CSI reporting or SP-CSI reporting on PUSCH, or in the CSI triggering MAC-CE for SP-CSI reporting on the PUCCH.

In some examples, the prioritization can be performed in one of two ways: from the first to the last indicated sub-configuration index or from the last to the first indicated sub-configuration index.

For instance, consider an A-CSI report configuration that has four sub-configurations. The CSI triggering state activated by the DCI may have the following information (meaning that sub-configurations 1/2/3 for AssociatedReportConfigID1):

$$CSI - AperiodicTriggerState 1 \{ associatedReportConfigInfoList = \{ AssociatedReportConfigID 1 \} associatedSubConfig = \{ 2 - 3 - 1 \} \} \qquad ( 3 )$$

Then, if prioritization is based on the order from the first indicated sub-configuration index to the last indicated sub-configuration index, the CSI associated with sub-configuration 2 gets the highest priority, while the CSI associated with sub-configuration 1 gets the lowest priority.

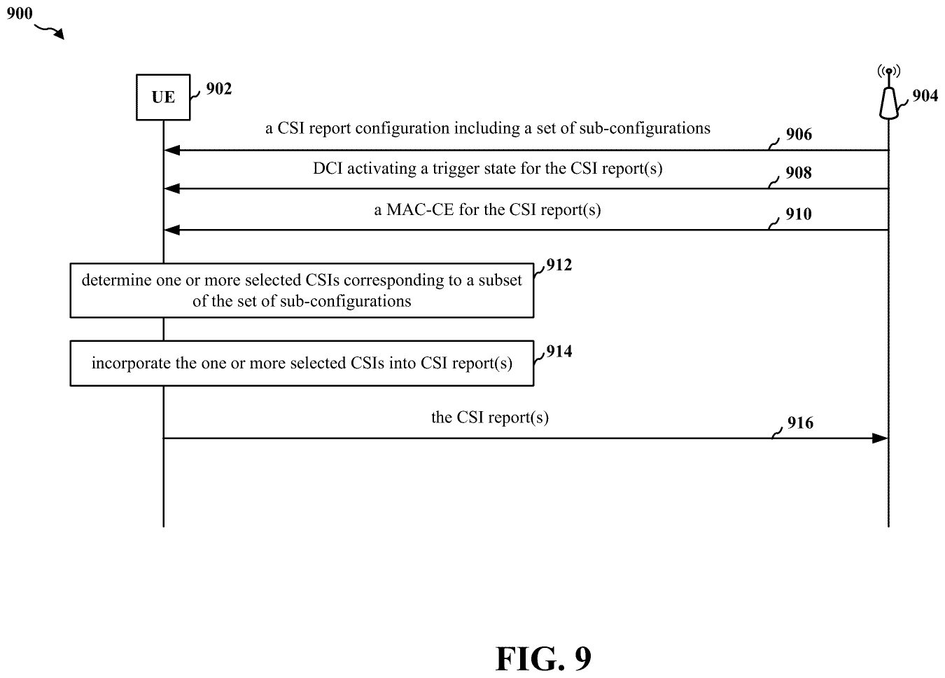

FIG. 9 is a call flow diagram 900 illustrating a method of wireless communication in accordance with various aspects of this present disclosure. Various aspects are described in connection with a UE 902 and a base station 904. The aspects may be performed by the UE 902 or the base station 904 in aggregation and/or by one or more components of a base station 904 (e.g., such as a CU 110, a DU 130, and/or an RU 140).

As shown in FIG. 9, at 906, a UE 902 may receive, from a base station 904, a CSI report configuration including a set of sub-configurations. Each sub-configuration in the set of sub-configurations may correspond to a transmission setting associated with a channel state information reference signal (CSI-RS). For example, the set of sub-configurations may correspond to a set of CSI-RS antenna port configurations or a set of power offset values between PDSCH and CSI-RS.

At 908, the UE 902 may receive DCI from the base station 904. The DCI may activate a trigger state for the CSI report, and the trigger state includes the order indicator for the CSI report. In one example, the trigger state may have the information shown in Equation (2), and the order indicator for the CSI report may be included in the values of parameter associatedSubConfig in Equation (2).

At 910, the UE 902 may receive a MAC-CE for the CSI report from the base station 904. The MAC-CE may include the order indicator for the CSI report.

In some aspects, the order indicator (in the DCI at 908 or the MAC-CE at 910) may include a sequence of sub-configuration indices indicating an order for the corresponding sub-configurations. In one example, the order for the corresponding sub-configurations may be from the first sub-configuration index to the last sub-configuration index in the sequence of sub-configuration indices. In another example, the order for the corresponding sub-configurations is from the last sub-configuration index to the first sub-configuration index in the sequence of sub-configuration indices. For example, referring to Equation (2), the sequence of sub-configuration indices may be {2, 3, 1}, as indicated by the values of parameter assoicatedSubConfig, and the order for the corresponding sub-configurations may be the order from the first sub-configuration index to the last sub-configuration index (e.g., the order of 2, 3, and 1) or from the last sub-configuration index to the first sub-configuration index in the sequence of sub-configuration indices (e.g., the order of 1, 3, and 2).

At 912, the UE 902 may determine one or more selected CSIs corresponding to a subset of the set of sub-configurations.

At 914, the UE 902 may incorporate the one or more selected CSIs into one or more CSI reports. For example, referring to FIG. 7A, the UE may incorporate the one or more selected CSIs (e.g., CSI₁, CSI₂, . . . , CSI_{N}) into one CSI report by concatenating the one or more selected CSIs (e.g., CSI₁, CSI₂, . . . , CSI_{N}). Referring to FIG. 7B, the UE may incorporate the one or more selected CSIs (e.g., CSI₁, CSI₂, . . . , CSI_{N}) into one CSI report by multiplexing the one or more selected CSIs (e.g., CSI₁, CSI₂, . . . , CSI_{N}). Referring to FIG. 8B, the UE may incorporate the one or more selected CSIs (CSIs for sub-configuration #0 852 and sub-configuration #1 854) into one CSI report (CSI report #1 844). Referring to FIG. 8C, the UE may incorporate the one or more selected CSIs (CSIs for sub-configuration #0 882 and sub-configuration #1 884) into multiple CSI reports (CSI report #1,0 874 and CSI report #1,1 876).

At 916, the UE 902 may transmit the one or more CSI reports based on the incorporation to the base station 904. For example, referring to FIG. 8B, the UE may transmit the CSI reports (e.g., 842, 844, 846) via the UCI bit sequence (e.g., 832), and the one or more selected CSIs corresponding to a subset of the set of sub-configurations (e.g., sub-configuration #0 852 and sub-configuration #1 854) may be incorporated into one CSI report (e.g., CSI report #1 844). Referring to FIG. 8C, the UE may transmit the CSI reports (e.g., 872, 874, 876, 878) via the UCI bit sequence (e.g., 862), and the one or more selected CSIs corresponding to a subset of the set of sub-configurations (e.g., sub-configuration #0 882 and sub-configuration #1 884) may be treated as if they are individual CSI reports (e.g., CSI report #1,0 874, CSI report #1,1 876).

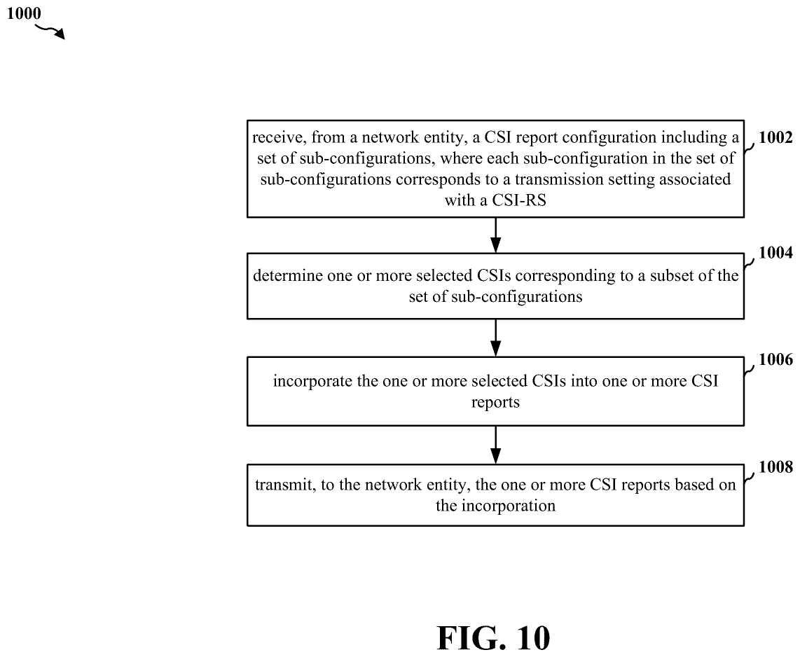

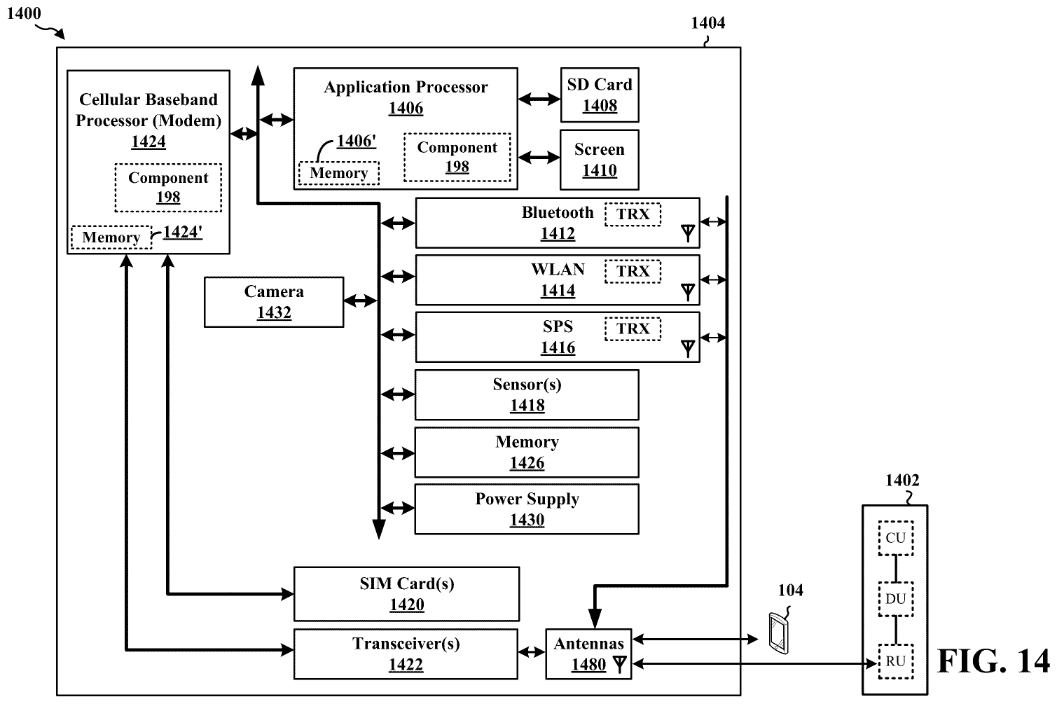

FIG. 10 is a flowchart 1000 illustrating methods of wireless communication at a UE in accordance with various aspects of the present disclosure. The method may be performed by a UE. The UE may be the UE 104, 350, 902, or the apparatus 1404 in the hardware implementation of FIG. 14. The methods enable the UE to flexibly manage multiple CSIs from multiple sub-configurations and prioritize the CSI reports based on the number of CSIs and sub-configurations. The methods optimize the CSI reporting process, leading to improved efficiency in terms of encoding, CSI management, and network communication.

As shown in FIG. 10, at 1002, the UE may receive, from a network entity, a CSI report configuration including a set of sub-configurations. Each sub-configuration in the set of sub-configurations may correspond to a transmission setting associated with a CSI-RS. The network entity may be a base station, or a component of a base station, in the access network of FIG. 1 or a core network component (e.g., base station 102, 310, 904; or the network entity 1402 in the hardware implementation of FIG. 14). FIGS. 7A, 7B, 8B. 8C, and 9 illustrate various aspects of the steps in connection with flowchart 1000. For example, referring to FIG. 9, the UE 902 may receive, at 906, from a network entity (base station 904), a CSI report configuration including a set of sub-configurations. Each sub-configuration in the set of sub-configurations may correspond to a transmission setting associated with a CSI-RS. For example, the set of sub-configurations may correspond to a set of CSI-RS antenna port configurations or a set of power offset values between PDSCH and CSI-RS. In some aspects, 1002 may be performed by the CSI configuration component 198.

At 1004, the UE may determine one or more selected CSIs corresponding to a subset of the set of sub-configurations. For example, referring to FIG. 9, the UE 902 may determine, at 912, one or more selected CSIs corresponding to a subset of the set of sub-configurations. Referring to Equation (2), the UE may determine three selected CSIs (i.e., N=3) corresponding to a subset of sub-configurations (corresponding to sub-configuration index of 2, 3, and 1) of the set of sub-configurations (e.g., L=4). In some aspects, 1004 may be performed by the CSI configuration component 198.

At 1006, the UE may incorporate the one or more selected CSIs into one or more CSI reports. For example, referring to FIG. 9, the UE 902 may, at 914, incorporate the one or more selected CSIs into one or more CSI reports. Referring to FIG. 7A, the UE may incorporate the one or more selected CSIs (e.g., CSI₁, CSI₂, . . . , CSI_{N}) into a CSI report by concatenating the one or more selected CSIs (e.g., CSI₁, CSI₂, . . . , CSI_{N}). Referring to FIG. 7B, the UE may incorporate the one or more selected CSIs (e.g., CSI₁, CSI₂, . . . , CSI_{N}) into a CSI report by multiplexing the one or more selected CSIs (e.g., CSI₁, CSI₂, . . . , CSI_{N}). Referring to FIG. 8B, the UE may incorporate the one or more selected CSIs (e.g., CSIs for sub-configuration #0 852 and sub-configuration #1 854) into one CSI report (e.g., CSI report #1 844). Referring to FIG. 8C, the UE may treat one or more selected CSIs (e.g., CSIs for sub-configuration #0 882 and sub-configuration #1 884) as if they are individual CSI reports (e.g., CSI report #1,0 874, CSI report #1,1 876) and incorporate the one or more selected CSIs (CSIs for sub-configuration #0 882 and sub-configuration #1 884) into multiple CSI reports (CSI report #1,0 874 and CSI report #1,1 876). In some aspects, 1006 may be performed by the CSI configuration component 198.

At 1008, the UE may transmit, to the network entity, the one or more CSI reports based on the incorporation. For example, referring to FIG. 9, the UE 902 may transmit, at 916, to the network entity (base station 904), the one or more CSI reports based on the incorporation (at 914). Referring to FIG. 8B, the UE may transmit one CSI report (e.g., CSI report #1 844) corresponding to multiple sub-configurations (e.g., sub-configurations #0 852 and sub-configurations #1 854). Referring to FIG. 8C, the UE may transmit multiple CSI reports (e.g., CSI report #1,0 874 and CSI report #1,1 876) respectively corresponding to multiple sub-configurations (e.g., sub-configurations #0 882 and sub-configurations #1 884). In some aspects, 1008 may be performed by the CSI configuration component 198.

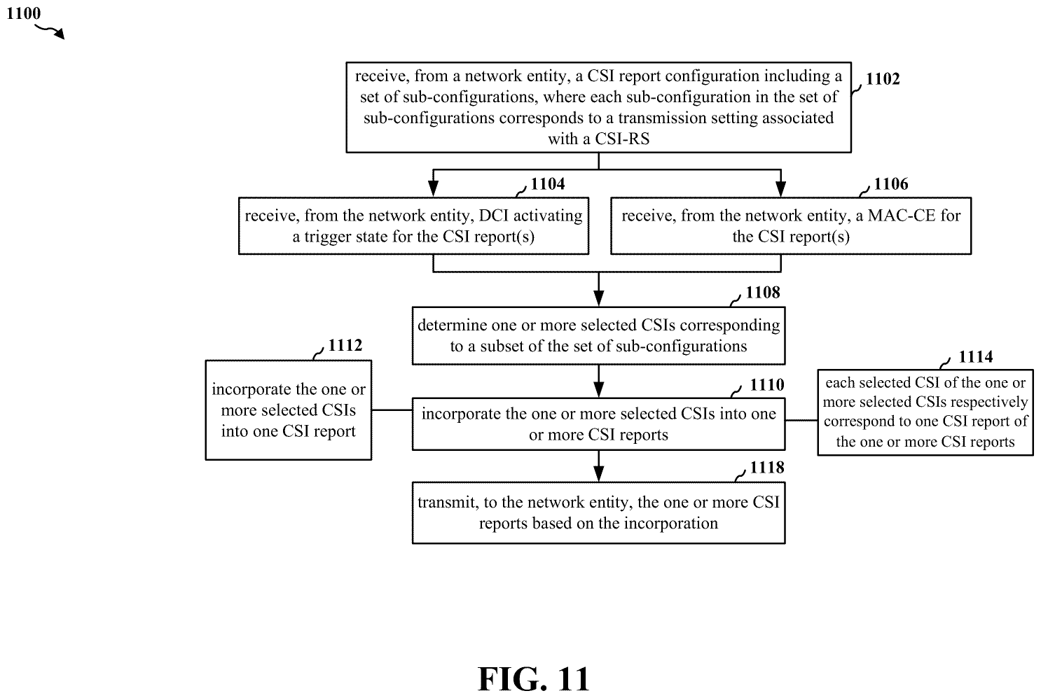

FIG. 11 is a flowchart 1100 illustrating methods of wireless communication at a UE in accordance with various aspects of the present disclosure. The method may be performed by a UE. The UE may be the UE 104, 350, 902, or the apparatus 1404 in the hardware implementation of FIG. 14. The methods enable the UE to flexibly manage multiple CSIs from multiple sub-configurations and prioritize the CSI reports based on the number of CSIs and sub-configurations. The methods optimize the CSI reporting process, leading to improved efficiency in terms of encoding, CSI management, and network communication.

As shown in FIG. 11, at 1102, the UE may receive, from a network entity, a CSI report configuration including a set of sub-configurations. Each sub-configuration in the set of sub-configurations may correspond to a transmission setting associated with a CSI-RS. The network entity may be a base station, or a component of a base station, in the access network of FIG. 1 or a core network component (e.g., base station 102, 310, 904; or the network entity 1402 in the hardware implementation of FIG. 14). FIGS. 7A, 7B, 8B, 8C, and 9 illustrate various aspects of the steps in connection with flowchart 1100. For example, referring to FIG. 9, the UE 902 may receive, at 906, from a network entity (base station 904), a CSI report configuration including a set of sub-configurations. Each sub-configuration in the set of sub-configurations may correspond to a transmission setting associated with a CSI-RS. For example, the set of sub-configurations may correspond to a set of CSI-RS antenna port configurations or a set of power offset values between PDSCH and CSI-RS. In some aspects, 1102 may be performed by the CSI configuration component 198.

At 1108, the UE may determine one or more selected CSIs corresponding to a subset of the set of sub-configurations. For example, referring to FIG. 9, the UE 902 may determine, at 912, one or more selected CSIs corresponding to a subset of the set of sub-configurations. Referring to Equation (2), the UE may determine three selected CSIs (i.e., N=3) corresponding to a subset of sub-configurations (corresponding to sub-configuration index of 2, 3, and 1) of the set of sub-configurations (e.g., L=4). In some aspects, 1108 may be performed by the CSI configuration component 198.

At 1110, the UE may incorporate the one or more selected CSIs into one or more CSI reports. For example, referring to FIG. 9, the UE 902 may, at 914, incorporate the one or more selected CSIs into one or more CSI reports. Referring to FIG. 7A, the UE may incorporate the one or more selected CSIs (e.g., CSI₁, CSI₂, . . . , CSI_{N}) into a CSI report by concatenating the one or more selected CSIs (e.g., CSI₁, CSI₂, . . . , CSI_{N}). Referring to FIG. 7B, the UE may incorporate the one or more selected CSIs (e.g., CSI₁, CSI₂, . . . , CSI_{N}) into a CSI report by multiplexing the one or more selected CSIs (e.g., CSI₁, CSI₂, . . . , CSI_{N}). Referring to FIG. 8B, the UE may incorporate the one or more selected CSIs (e.g., CSIs for sub-configuration #0 852 and sub-configuration #1 854) into one CSI report (e.g., CSI report #1 844). Referring to FIG. 8C, the UE may treat one or more selected CSIs (e.g., CSIs for sub-configuration #0 882 and sub-configuration #1 884) as if they are individual CSI reports (e.g., CSI report #1,0 874, CSI report #1,1 876) and incorporate the one or more selected CSIs (CSIs for sub-configuration #0 882 and sub-configuration #1 884) into multiple CSI reports (CSI report #1,0 874 and CSI report #1,1 876). In some aspects, 1110 may be performed by the CSI configuration component 198.

At 1118, the UE may transmit, to the network entity, the one or more CSI reports based on the incorporation. For example, referring to FIG. 9, the UE 902 may transmit, at 916, to the network entity (base station 904), the one or more CSI reports based on the incorporation (at 914). Referring to FIG. 8B, the UE may transmit one CSI report (e.g., CSI report #1 844) corresponding to multiple sub-configurations (e.g., sub-configurations #0 852 and sub-configurations #1 854). Referring to FIG. 8C, the UE may transmit multiple CSI reports (e.g., CSI report #1,0 874 and CSI report #1,1 876) respectively corresponding to multiple sub-configurations (e.g., sub-configurations #0 882 and sub-configurations #1 884). In some aspects, 1118 may be performed by the CSI configuration component 198.

In some aspects, the one or more selected CSIs may each include a first part. To transmit the one or more CSI reports (at 1118), the UE may transmit, to the network entity, one or more UCI bit sequences including the one or more CSI reports. For example, referring to FIG. 8B and FIG. 8C, the UE may transmit one or more UCI bit sequences (e.g., 832, 862) including the one or more CSI reports (e.g., CSI reports 844, 874, and 876).

In some aspects, to incorporate the one or more selected CSIs into one or more CSI reports (at 1110), the UE may, at 1112, incorporate the one or more selected CSIs into one CSI report. The one CSI report may include an incorporated first part based on the first parts of the one or more selected CSIs. For example, referring to FIG. 8B, the UE may incorporate the one or more selected CSIs (CSIs for sub-configuration #0 852 and sub-configuration #1 854) into one CSI report (CSI report #1 844). Referring to FIG. 7A, the one CSI report may include an incorporated first part (e.g., 702) based on the first parts of the one or more selected CSIs (e.g., 712, 714). In some aspects, 1112 may be performed by the CSI configuration component 198.

In some aspects, to incorporate the one or more selected CSIs into the one CSI report (at 1112), the UE may concatenate the first parts of the one or more selected CSIs corresponding to the subset of the set of sub-configurations to form the incorporated first part for the one CSI report. For example, referring to FIG. 7A, the UE may concatenate the first parts of the one or more selected CSIs (e.g., CSI₁, CSI₂, . . . , CSI_{N}) corresponding to the subset of the set of sub-configurations to form the incorporated first part (702) for the one CSI report.

In some aspects, the one or more selected CSIs may each further include a second part, and the CSI report may further include an incorporated second part. To incorporate the one or more selected CSIs into the one CSI report (at 1112), the UE may concatenate the second parts of the one or more selected CSIs to form the incorporated second part of the one CSI report. For example, referring to FIG. 7A, the UE may concatenate the second parts of the one or more selected CSIs (e.g., CSI₁. CSI₂, . . . , CSI_{N}) to form the incorporated second part (732) of the one CSI report.

In some aspects, to incorporate the one or more selected CSIs into the one CSI report (at 1112), the UE may multiplex the first parts of the one or more selected CSIs to form the incorporated first part for the one CSI report. For example, referring to FIG. 7B, the UE may multiplex the first parts of the one or more selected CSIs (e.g., CSI₁, CSI₂, . . . , CSI_{N}) to form the incorporated first part (752) for the one CSI report.

In some aspects, the one or more selected CSIs may each further include a second part, and the CSI report may further include an incorporated second part. To incorporate the one or more selected CSIs into the one CSI report (at 1112), the UE may multiplex the second parts of the one or more selected CSIs to form the incorporated second part for the one CSI report. For example, referring to FIG. 9, when incorporating the one or more selected CSIs into the one CSI report (at 914), the UE 902 may multiplex the second parts of the one or more selected CSIs to form the incorporated second part for the one CSI report.

In some aspects, at 1114, each selected CSI of the one or more selected CSIs may respectively correspond to one CSI report of the one or more CSI reports, and the one or more UCI bit sequences may include a first UCI bit sequence. To incorporate the one or more selected CSIs into the one or more CSI reports (at 1110), the UE may multiplex the first parts of the one or more selected CSIs to form the first UCI bit sequence. For example, referring to FIG. 8C, each selected CSI of the one or more selected CSIs (CSIs for sub-configuration #0 882 and sub-configuration #1 884) may respectively correspond to one CSI report of the one or more CSI reports (e.g., CSI report #1,0 874 and CSI report #1,1 876), and the one or more UCI bit sequences may include a first UCI bit sequence (e.g., UCI bit sequence for Part k CSI 862, with k=1).

In some aspects, the one or more selected CSIs may each further include a second part, and the one or more UCI bit sequences may further include a second UCI bit sequence. To incorporate the one or more selected CSIs into the one or more CSI reports (at 1110), the UE may multiplex the second parts of the one or more selected CSIs to form the second UCI bit sequence. For example, referring to FIG. 8C, the one or more UCI bit sequences may further include a second UCI bit sequence (e.g., UCI bit sequence for Part k CSI 862, with k=2). To incorporate the one or more selected CSIs into the one or more CSI reports, the UE may multiplex the second parts of the one or more selected CSIs to form the second UCI bit sequence (e.g., UCI bit sequence for Part k CSI 862, with k=2).

In some aspects, to incorporate the one or more selected CSIs into the one or more CSI reports (at 1110), the UE may incorporate the one or more selected CSIs into the one or more CSI reports based on an order indicator. The order indicator may include a sequence of sub-configuration indices indicating an order for the corresponding sub-configurations. For example, referring to Equation (2), the order indicator may include a sequence of sub-configuration indices (e.g., the indices of 2, 3, and 1) indicating an order for the corresponding sub-configurations.

In some aspects, the order for the corresponding sub-configurations may be from the first sub-configuration index to the last sub-configuration index in the sequence of sub-configuration indices. For example, referring to Equation (2), based on the sequence of sub-configuration indices of 2, 3, and 1, the order for the corresponding sub-configurations may be from the first sub-configuration index to the last sub-configuration index (e.g., in the order of 2, 3, and 1).

In some aspects, the order for the corresponding sub-configurations may be from the last sub-configuration index to the first sub-configuration index in the sequence of sub-configuration indices. For example, referring to Equation (2), based on the sequence of sub-configuration indices of 2, 3, and 1, the order for the corresponding sub-configurations may be from the last sub-configuration index to the first sub-configuration index (e.g., in the order of 1, 3, and 2).

In some aspects, the one or more CSI reports may be A-CSI reports or SP-CSI reports on a PUSCH, and the UE may, at 1104, receive, from the network entity, DCI activating a trigger state for the one or more CSI reports. The trigger state may include the order indicator. For example, referring to FIG. 9, the UE 902 may, at 908, receive, from the network entity (base station 904), DCI activating a trigger state for the one or more CSI reports. The trigger state may include the order indicator. In some aspects, 1104 may be performed by the CSI configuration component 198.

In some aspects, the one or more CSI reports may be SP-CSI reports on a PUCCH, and, at 1106, the UE may receive, from the network entity, a MAC-CE for the one or more CSI reports. The MAC-CE may include the order indicator. For example, referring to FIG. 9, the UE 902 may receive, at 910, from the network entity (base station 904), a MAC-CE for the one or more CSI reports. The MAC-CE may include the order indicator. In some aspects, 1106 may be performed by the CSI configuration component 198.

In some aspects, the one or more CSI reports may be P-CSI reports, and the CSI report configuration may include the order indicator. For example, referring to FIG. 9, for the P-CSI report, the CSI report configuration (at 906) may include the order indicator.

In some aspects, to incorporate the one or more selected CSIs into the one or more CSI reports (at 1110), the UE may drop, based on the order indicator, one or more dropped CSIs to obtain the one or more selected CSIs. For example, referring to Equation (2), based on the order indicator (the sequence of sub-configuration indices of 2, 3, and 1) the UE may drop one or more dropped CSIs (the CSI corresponding to sub-configuration index of 4, assuming the set of sub-configurations include four sub-configurations).

In some aspects, to transmit the one or more CSI reports (at 1118), the UE may transmit the one or more CSI report according to the first report priority of the one or more CSI reports. The first report priority may be based on the first number of sub-configurations in the subset of sub-configurations. For example, referring to FIG. 9, when transmitting the one or more CSI reports (at 916), the UE 902 may transmit the one or more CSI reports according to the first report priority of the one or more CSI reports. The first report priority may be based on the first number of sub-configurations (e.g., N) in the subset of sub-configurations.

In some aspects, the first report priority of the one or more CSI reports with more than one sub-configuration in the subset of sub-configurations may be the same as (or equal to) a second report priority for a second CSI report with one sub-configuration in the subset of sub-configurations or a third report priority for a regular CSI not involving a sub-configuration. For example, the first report priority of the one or more CSI reports with more than one sub-configuration (e.g., N>1) in the subset of sub-configurations may be the same as (or equal to) a second report priority for a second CSI report with one sub-configuration (e.g., N=1) in the subset of sub-configurations or a third report priority for a regular CSI not involving a sub-configuration.

In some aspects, the first report priority of the one or more CSI reports with more than one sub-configuration in the subset of sub-configurations may be higher than a second report priority for a second CSI report with one sub-configuration in the subset of sub-configurations or a third report priority for a regular CSI not involving a sub-configuration. For example, the first report priority of the CSI report with more than one sub-configuration (e.g., N>1) in the subset of sub-configurations may be higher than a second report priority for a second CSI report with one sub-configuration (e.g., N=1) in the subset of sub-configurations or a third report priority for a regular CSI not involving a sub-configuration.

In some aspects, the first report priority of the one or more CSI reports with more than one sub-configuration in the subset of sub-configurations may be lower than a second report priority for a second CSI report with one sub-configuration in the subset of sub-configurations or a third report priority for a regular CSI not involving a sub-configuration. For example, the first report priority of the CSI report with more than one sub-configuration (e.g., N>1) in the subset of sub-configurations may be lower than a second report priority for a second CSI report with one sub-configuration (e.g., N=1) in the subset of sub-configurations or a third report priority for a regular CSI not involving a sub-configuration.

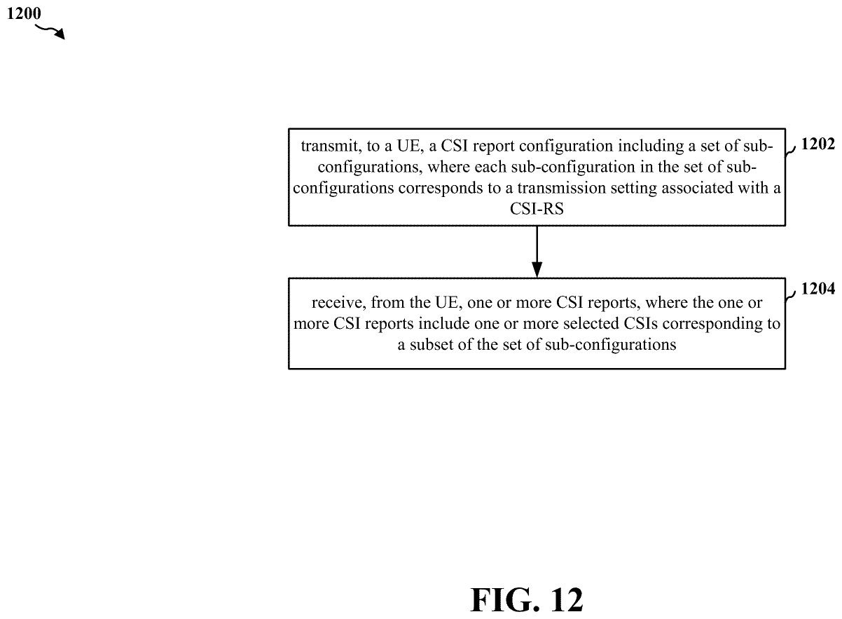

FIG. 12 is a flowchart 1200 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 904; or the network entity 1402 in the hardware implementation of FIG. 14). The methods enable the UE to flexibly manage multiple CSIs from multiple sub-configurations and prioritize the CSI reports based on the number of CSIs and sub-configurations. The methods optimize the CSI reporting process, leading to improved efficiency in terms of encoding, CSI management, and network communication.

As shown in FIG. 12, at 1202, the network entity may transmit, to a UE, a CSI report configuration including a set of sub-configurations. Each sub-configuration in the set of sub-configurations may correspond to a transmission setting associated with a CSI-RS. The UE may be the UE 104, 350, 902, or the apparatus 1404 in the hardware implementation of FIG. 14. FIGS. 7A, 7B, 8B, 8C, and 9 illustrate various aspects of the steps in connection with flowchart 1200. For example, referring to FIG. 9, the network entity (base station 904) may transmit, at 906, to a UE 902, a CSI report configuration including a set of sub-configurations. Each sub-configuration in the set of sub-configurations may correspond to a transmission setting associated with a CSI-RS. For example, the set of sub-configurations may correspond to a set of CSI-RS antenna port configurations or a set of power offset values between PDSCH and CSI-RS. In some aspects, 1202 may be performed by the CSI configuration component 199.

At 1204, the network entity may receive, from the UE, one or more CSI reports. The one or more CSI reports may include one or more selected CSIs corresponding to a subset of the set of sub-configurations. For example, referring to FIG. 9, the network entity (base station 904) may receive, at 916, from the UE 902, one or more CSI reports. The one or more CSI reports may include one or more selected CSIs corresponding to a subset of the set of sub-configurations. Referring to FIG. 7A, the CSI report may include one or more selected CSIs (e.g., CSI₁, CSI₂, . . . , CSI_{N}) corresponding to a subset of the set of sub-configurations. In some aspects, 1304 may be performed by the CSI configuration component 199.

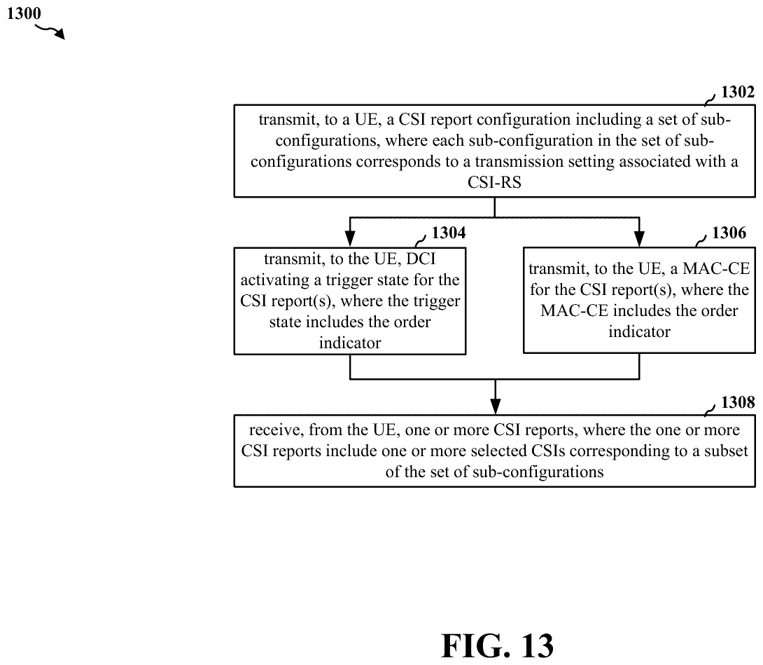

FIG. 13 is a flowchart 1300 illustrating methods of wireless communication at a network entity in accordance with various aspects of the present disclosure. The method may be performed by a network entity. The network entity may be a base station, or a component of a base station, in the access network of FIG. 1 or a core network component (e.g., base station 102, 310, 904; or the network entity 1402 in the hardware implementation of FIG. 14). The methods enable the UE to flexibly manage multiple CSIs from multiple sub-configurations and prioritize the CSI reports based on the number of CSIs and sub-configurations. The methods optimize the CSI reporting process, leading to improved efficiency in terms of encoding, CSI management, and network communication.

As shown in FIG. 13, at 1302, the network entity may transmit, to a UE, a CSI report configuration including a set of sub-configurations. Each sub-configuration in the set of sub-configurations may correspond to a transmission setting associated with a CSI-RS. The UE may be the UE 104, 350, 902, or the apparatus 1404 in the hardware implementation of FIG. 14. FIGS. 7A, 7B, 8B, 8C, and 9 illustrate various aspects of the steps in connection with flowchart 1300. For example, referring to FIG. 9, the network entity (base station 904) may transmit, at 906, to a UE 902, a CSI report configuration including a set of sub-configurations. Each sub-configuration in the set of sub-configurations may correspond to a transmission setting associated with a CSI-RS. For example, the set of sub-configurations may correspond to a set of CSI-RS antenna port configurations or a set of power offset values between PDSCH and CSI-RS. In some aspects, 1302 may be performed by the CSI configuration component 199.

At 1308, the network entity may receive, from the UE, one or more CSI reports. The one or more CSI reports may include one or more selected CSIs corresponding to a subset of the set of sub-configurations. For example, referring to FIG. 9, the network entity (base station 904) may receive, at 916, from the UE 902, one or more CSI reports. The one or more CSI reports may include one or more selected CSIs corresponding to a subset of the set of sub-configurations. Referring to FIG. 7A, the CSI report may include one or more selected CSIs (e.g., CSI₁, CSI₂, . . . , CSI_{N}) corresponding to a subset of the set of sub-configurations. In some aspects, 1308 may be performed by the CSI configuration component 199.

In some aspects, the one or more selected CSIs may each include a first part. To receive the one or more CSI reports (at 1308), the network entity may receive, from the UE, one or more UCI bit sequences including the one or more CSI reports. For example, referring to FIG. 7A, the one or more selected CSIs (e.g., CSI₁, CSI₂) may each include a first part (e.g., Part 1 712 of CSI₁, Part 1 714 of CSI₂). Referring to FIG. 8C, to receive the one or more CSI reports (e.g., CSI report #1,0 874, CSI report #1,1 876), the network entity may receive, from the UE, one or more UCI bit sequences (e.g., UCI bit sequence for Part k CSI 862, where k may be 1 or 2) including the one or more CSI reports (e.g., CSI report #1,0 874, CSI report #1,1 876).

In some aspects, to receive the one or more CSI reports (at 1308), the network entity may receive one CSI report including the one or more selected CSIs corresponding to the subset of the set of sub-configurations. The one CSI report may include an incorporated first part based on the concatenation of the first parts of the one or more selected CSIs corresponding to the subset of the set of sub-configurations, or the multiplexing of the first parts of the one or more selected CSIs corresponding to the subset of the set of sub-configurations. For example, referring to FIG. 8B, the network entity may receive one CSI report (CSI report #1 844) including the one or more selected CSIs corresponding to the subset of the set of sub-configurations (e.g., sub-configuration #0 852 and sub-configuration #1 854). The one CSI report (e.g., CSI report #1 844) may include an incorporated first part. Referring to FIG. 7A, the incorporated first part (702) may be configured based on the concatenation of the first parts of the one or more selected CSIs (e.g., CSI₁, CSI₂, . . . , CSI_{N}) corresponding to the subset of the set of sub-configurations. Referring to FIG. 7B, the incorporated first part (752) may be configured based on the multiplexing of the first parts of the one or more selected CSIs (e.g., CSI₁, CSI₂, . . . , CSI_{N}) corresponding to the subset of the set of sub-configurations.

In some aspects, the one or more selected CSIs corresponding to the subset of the set of sub-configurations in the one or more CSI reports may be based on an order indicator. The order indicator may include a sequence of sub-configuration indices indicating an order for the corresponding sub-configurations. For example, referring to Equation (2), the order indicator may include a sequence of sub-configuration indices (the sub-configuration indices of 2, 3, and 1) indicating an order for the corresponding sub-configurations.

In some aspects, the order for the corresponding sub-configurations may be one of: from the first sub-configuration index to the last sub-configuration index in the sequence of sub-configuration indices, or from the last sub-configuration index to the first sub-configuration index in the sequence of sub-configuration indices. For example, referring to Equation (2), the order for the corresponding sub-configurations may be one of: from the first sub-configuration index to the last sub-configuration index in the sequence of sub-configuration indices (e.g., at the order of sub-configuration indices 2, 3, and 1), or from the last sub-configuration index to the first sub-configuration index in the sequence of sub-configuration indices (e.g., at the order of sub-configuration indices 1, 3, and 2).

In some aspects, the one or more CSI reports may be A-CSI reports or SP-CSI reports on a PUSCH, and, at 1304, the network entity may transmit, to the UE, DCI activating a trigger state for the one or more CSI reports. The trigger state may include the order indicator. For example, referring to FIG. 9, the network entity (base station 904) may transmit, at 908, to the UE 902, DCI activating a trigger state for the one or more CSI reports. In some aspects, 1304 may be performed by the CSI configuration component 199.

In some aspects, the one or more CSI reports may be SP-CSI reports on a PUCCH, and, at 1306, the network entity may transmit, to the UE, a MAC-CE for the one or more CSI reports. The MAC-CE may include the order indicator. For example, referring to FIG. 9, the network entity (base station 904) may transmit, at 910, to the UE 902, a MAC-CE for the one or more CSI reports. The MAC-CE may include the order indicator. In some aspects, 1306 may be performed by the CSI configuration component 199.

In some aspects, the one or more CSI reports may be P-CSI reports, and the CSI report configuration may include the order indicator. For example, referring to FIG. 9, the CSI report configuration (at 906) may include the order indicator.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The cellular baseband processor(s) 1424 and the application processor(s) 1406 are configured to perform the various functions described supra based at least in part of the information stored in the memory. That is, the cellular baseband processor(s) 1424 and the application processor(s) 1406 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the at least one memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 350 of FIG. 3) and include the additional modules of the apparatus 1404.

As discussed supra, the component 198 may be configured to receive, from a network entity, a CSI report configuration including a set of sub-configurations, where each sub-configuration in the set of sub-configurations corresponds to a transmission setting associated with a CSI-RS; determine one or more selected CSIs corresponding to a subset of the set of sub-configurations; incorporate the one or more selected CSIs into one or more CSI reports; and transmit, to the network entity, the one or more CSI reports based on the incorporation. The component 198 may be further configured to perform any of the aspects described in connection with the flowcharts in FIG. 10 and FIG. 11, and/or performed by the UE 902 in FIG. 9. The component 198 may be within the cellular baseband processor(s) 1424, the application processor(s) 1406, or both the cellular baseband processor(s) 1424 and the application processor(s) 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, includes means for receiving, from a network entity, a CSI report configuration including a set of sub-configurations, where each sub-configuration in the set of sub-configurations corresponds to a transmission setting associated with a CSI-RS, means for determining one or more selected CSIs corresponding to a subset of the set of sub-configurations, means for incorporating the one or more selected CSIs into one or more CSI reports, and means for transmitting, to the network entity, the one or more CSI reports based on the incorporation. The apparatus 1404 may further include means for performing any of the aspects described in connection with the flowcharts in FIG. 10 and FIG. 11, and/or aspects performed by the UE 902 in FIG. 9. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

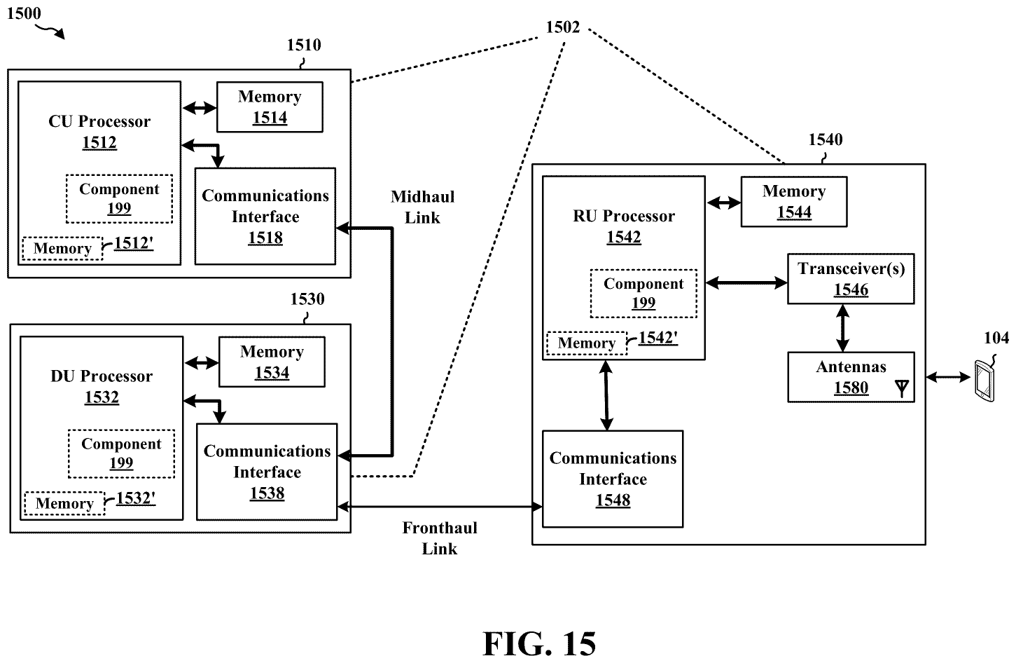

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, to a UE, a CSI report configuration including a set of sub-configurations, where each sub-configuration in the set of sub-configurations corresponds to a transmission setting associated with a CSI-RS; and receive, from the UE, a CSI report, where the CSI report includes one or more selected CSIs corresponding to a subset of the set of sub-configurations. The component 199 may be further configured to perform any of the aspects described in connection with the flowcharts in FIG. 12 and FIG. 13, and/or performed by the base station 904 in FIG. 9. The component 199 may be within one or more processors of one or more of the CU 1510, DU 1530, and the RU 1540. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 includes means for transmitting, to a UE, a CSI report configuration including a set of sub-configurations, where each sub-configuration in the set of sub-configurations corresponds to a transmission setting associated with a CSI-RS, and means for receiving, from the UE, a CSI report, where the CSI report includes one or more selected CSIs corresponding to a subset of the set of sub-configurations. The network entity 1502 may further include means for performing any of the aspects described in connection with the flowcharts in FIG. 12 and FIG. 13, and/or aspects performed by the base station 904 in FIG. 9. The means may be the component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include receiving, from a network entity, a CSI report configuration including a set of sub-configurations, where each sub-configuration in the set of sub-configurations corresponds to a transmission setting associated with a CSI-RS; determining one or more selected CSIs corresponding to a subset of the set of sub-configurations; incorporating the one or more selected CSIs into one or more CSI reports; and transmitting, to the network entity, the one or more CSI reports based on the incorporation. The methods enable the UE to flexibly manage multiple CSIs from multiple sub-configurations and prioritize the CSI reports based on the number of CSIs and sub-configurations. The methods optimize the CSI reporting process, leading to improved efficiency in terms of encoding, CSI management, and network communication.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method may include receiving, from a network entity, a channel state information (CSI) report configuration including a set of sub-configurations, wherein each sub-configuration in the set of sub-configurations corresponds to a transmission setting associated with a channel state information reference signal (CSI-RS); determining one or more selected CSIs corresponding to a subset of the set of sub-configurations; incorporating the one or more selected CSIs into one or more CSI reports; and transmitting, to the network entity, the one or more CSI reports based on the incorporation.

Aspect 2 is the method of aspect 1, wherein the one or more selected CSIs may each include the first part. Transmitting the one or more CSI reports may include transmitting one or more uplink control information (UCI) bit sequences including the one or more CSI reports to the network entity.

Aspect 3 is the method of aspect 2, wherein incorporating the one or more selected CSIs into the one or more CSI reports may include: incorporating the one or more selected CSIs into one CSI report. The one CSI report may include an incorporated first part based on the first parts of the one or more selected CSIs.

Aspect 4 is the method of aspect 3, wherein incorporating the one or more selected CSIs into the one CSI report may include concatenating the first parts of the one or more selected CSIs corresponding to the subset of the set of sub-configurations to form the incorporated first part for the one CSI report.

Aspect 5 is the method of aspect 4, wherein the one or more selected CSIs may each further include a second part, the one CSI report may further include an incorporated second part, and incorporating the one or more selected CSIs into the one CSI report may include: concatenating the second parts of the one or more selected CSIs to form the incorporated second part of the one CSI report.

Aspect 6 is the method of aspect 3, wherein incorporating the one or more selected CSIs into the one CSI report may include: multiplexing the first parts of the one or more selected CSIs corresponding to the subset of the set of sub-configurations to form the incorporated first part for the one CSI report.

Aspect 7 is the method of aspect 6, wherein the one or more selected CSIs may each further include a second part, the one CSI report may further include an incorporated second part, and incorporating the one or more selected CSIs into the one CSI report may include: multiplexing the second parts of the one or more selected CSIs to form the incorporated second part for the one CSI report.

Aspect 8 is the method of aspect 2, wherein each selected CSI of the one or more selected CSIs may respectively correspond to one CSI report of the one or more CSI reports, and the one or more UCI bit sequences may include the first UCI bit sequence. Incorporating the one or more selected CSIs into the one or more CSI reports may include multiplexing the first parts of the one or more selected CSIs to form the first UCI bit sequence.

Aspect 9 is the method of aspect 8, wherein the one or more selected CSIs may each further include a second part, and the one or more UCI bit sequences may further include a second UCI bit sequence. Incorporating the one or more selected CSIs into the one or more CSI reports may further include multiplexing the second parts of the one or more selected CSIs to form the second UCI bit sequence.

Aspect 10 is the method of any of aspects 1 to 9, wherein incorporating the one or more selected CSIs into the one or more CSI reports may include: incorporating the one or more selected CSIs into the one or more CSI reports based on an order indicator, wherein the order indicator may include a sequence of sub-configuration indices indicating an order for the corresponding sub-configurations.

Aspect 11 is the method of aspect 10, wherein the order for the corresponding sub-configurations may be from the first sub-configuration index to the last sub-configuration index in the sequence of sub-configuration indices.

Aspect 12 is the method of aspect 10, wherein the order for the corresponding sub-configurations may be from the last sub-configuration index to the first sub-configuration index in the sequence of sub-configuration indices.

Aspect 13 is the method of any of aspects 10 to 12, wherein the one or more CSI reports may be aperiodic CSI (A-CSI) reports or semi-persistent CSI (SP-CSI) reports on a physical uplink shared channel (PUSCH), and the method may further include: receiving, from the network entity, downlink control information (DCI) activating a trigger state for the one or more CSI reports, wherein the trigger state may include the order indicator.

Aspect 14 is the method of any of aspects 10 to 12, wherein the one or more CSI reports may be semi-persistent CSI (SP-CSI) reports on a physical uplink control channel (PUCCH), and the method may further include: receiving, from the network entity, a medium access control (MAC)-control element (MAC-CE) for the one or more CSI reports, wherein the MAC-CE may include the order indicator.

Aspect 15 is the method of any of aspects 10 to 12, wherein the one or more CSI reports may be periodic CSI (P-CSI) reports, and the CSI report configuration may include the order indicator.

Aspect 16 is the method of any of aspects 1 to 15, wherein incorporating the one or more selected CSIs corresponding to the subset of the set of sub-configurations into the one or more CSI reports may include: dropping, based on the order indicator, one or more dropped CSIs to obtain the one or more selected CSIs.

Aspect 17 is the method of any of aspects 1 to 16, wherein transmitting the one or more CSI reports may include: transmitting the one or more CSI reports according to the first report priority of the one or more CSI reports, wherein the first report priority may be based on the first number of sub-configurations in the subset of sub-configurations.

Aspect 18 is the method of aspect 17, wherein the first report priority of the one or more CSI reports with more than one sub-configuration in the subset of sub-configurations may be equal to a second report priority for a second CSI report with one sub-configuration in the subset of sub-configurations or a third report priority for a regular CSI not involving a sub-configuration.

Aspect 19 is the method of aspect 17, wherein the first report priority of the one or more CSI reports with more than one sub-configuration in the subset of sub-configurations may be higher than a second report priority for a second CSI report with one sub-configuration in the subset of sub-configurations or a third report priority for a regular CSI not involving a sub-configuration.

Aspect 20 is the method of aspect 17, wherein the first report priority of the one or more CSI reports with more than one sub-configuration in the subset of sub-configurations may be lower than a second report priority for a second CSI report with one sub-configuration in the subset of sub-configurations or a third report priority for a regular CSI not involving a sub-configuration.

Aspect 21 is an apparatus for wireless communication at a UE, comprising: at least one memory; and at least one processor coupled to the at least one memory and, based at least in part on information stored in the at least one memory, the at least one processor, individually or in any combination, is configured to perform the method of any of aspects 1-20.

Aspect 22 is the apparatus for wireless communication at a UE, comprising means for performing each step in the method of any of aspects 1-20.

Aspect 23 is an apparatus of any of aspects 21-22, further comprising a transceiver configured to receive or to transmit in association with the method of any of aspects 1-20.

Aspect 24 is a computer-readable medium (e.g., a non-transitory computer-readable medium) storing computer executable code at a UE, the code when executed by at least one processor causes the at least one processor to, individually or in any combination, perform the method of any of aspects 1-20.

Aspect 25 is a method of wireless communication at a network entity. The method may include transmitting, to a user equipment (UE), a channel state information (CSI) report configuration including a set of sub-configurations, wherein each sub-configuration in the set of sub-configurations may correspond to a transmission setting associated with a channel state information reference signal (CSI-RS); and receiving, from the UE, one or more CSI reports including one or more selected CSIs corresponding to a subset of the set of sub-configurations.

Aspect 26 is the method of aspect 25, wherein the one or more selected CSIs may each include a first part. Receiving the one or more CSI reports may include receiving, from the UE, one or more uplink control information (UCI) bit sequences including the one or more CSI reports.

Aspect 27 is the method of aspect 26, wherein receiving the one or more CSI reports may include receiving one CSI report including the one or more selected CSIs corresponding to the subset of the set of sub-configurations. The one CSI report may include an incorporated first part based on the concatenation of the first parts of the one or more selected CSIs corresponding to the subset of the set of sub-configurations, or the multiplexing of the first parts of the one or more selected CSIs corresponding to the subset of the set of sub-configurations.

Aspect 28 is the method of any of aspects 25 to 27, wherein the one or more selected CSIs corresponding to the subset of the set of sub-configurations in the one or more CSI reports may be based on an order indicator, wherein the order indicator may include a sequence of sub-configuration indices indicating an order for the corresponding sub-configurations.

Aspect 29 is the method of aspect 28, wherein the order for the corresponding sub-configurations may be one of: from the first sub-configuration index to the last sub-configuration index in the sequence of sub-configuration indices, or from the last sub-configuration index to the first sub-configuration index in the sequence of sub-configuration indices.

Aspect 30 is the method of aspect 29, wherein the one or more CSI reports may be aperiodic CSI (A-CSI) reports or semi-persistent CSI (SP-CSI) reports on a physical uplink shared channel (PUSCH), and the method may further include: transmitting, to the UE, downlink control information (DCI) activating a trigger state for the one or more CSI reports, wherein the trigger state may include the order indicator.

Aspect 31 is the method of aspect 29, wherein the one or more CSI reports may be semi-persistent CSI (SP-CSI) reports on a physical uplink control channel (PUCCH), and the method may further include: transmitting, to the UE, a medium access control (MAC)-control element (MAC-CE) for the one or more CSI reports, wherein the MAC-CE may include the order indicator.

Aspect 32 is the method of aspect 29, wherein the one or more CSI reports may be periodic CSI (P-CSI) reports, and the CSI report configuration may include the order indicator.

Aspect 33 is an apparatus for wireless communication at a network entity, comprising: at least one memory; and at least one processor coupled to the at least one memory and, based at least in part on information stored in the at least one memory, the at least one processor, individually or in any combination, is configured to perform the method of any of aspects 25-32.

Aspect 34 is the apparatus for wireless communication at a network entity, comprising means for performing each step in the method of any of aspects 25-32.

Aspect 35 is an apparatus of any of aspects 33-34, further comprising a transceiver configured to receive or to transmit in association with the method of any of aspects 25-32.

Aspect 36 is a computer-readable medium (e.g., a non-transitory computer-readable medium) storing computer executable code at a network entity, the code when executed by at least one processor causes the at least one processor to, individually or in any combination, perform the method of any of aspects 25-32.

What is claimed is:

1. An apparatus of wireless communication for a user equipment (UE), comprising:
at least one memory; and
at least one processor coupled to the at least one memory and, based at least in part on information stored in the at least one memory, the at least one processor, individually or in any combination, is configured to:
receive, from a network entity, a channel state information (CSI) report configuration comprising a set of sub-configurations, wherein each sub-configuration in the set of sub-configurations corresponds to a transmission setting associated with a channel state information reference signal (CSI-RS);
determine one or more selected CSIs corresponding to a subset of the set of sub-configurations;
incorporate the one or more selected CSIs into one or more CSI reports; and
transmit, to the network entity, the one or more CSI reports based on the incorporation.

2. The apparatus of claim 1, further comprising a transceiver coupled to the at least one processor, wherein, to receive the CSI report configuration, the at least one processor, individually or in any combination, is configured to receive the CSI report configuration via the transceiver, the one or more selected CSIs each include a first part, and wherein to transmit the one or more CSI reports, the at least one processor, individually or in any combination, is configured to:
transmit, to the network entity, one or more uplink control information (UCI) bit sequences comprising the one or more CSI reports.

3. The apparatus of claim 2, wherein, to incorporate the one or more selected CSIs into the one or more CSI reports, the at least one processor, individually or in any combination, is further configured to:
incorporate the one or more selected CSIs into one CSI report, wherein the one CSI report includes an incorporated first part based on the first parts of the one or more selected CSIs.

4. The apparatus of claim 3, wherein, to incorporate the one or more selected CSIs into the one CSI report, the at least one processor, individually or in any combination, is configured to:
concatenate the first parts of the one or more selected CSIs corresponding to the subset of the set of sub-configurations to form the incorporated first part for the one CSI report.

5. The apparatus of claim 4, wherein the one or more selected CSIs each further include a second part, the one CSI report further includes an incorporated second part, and wherein, to incorporate the one or more selected CSIs into the one CSI report, the at least one processor, individually or in any combination, is configured to:
concatenate the second parts of the one or more selected CSIs to form the incorporated second part of the one CSI report.

6. The apparatus of claim 3, wherein, to incorporate the one or more selected CSIs into the one CSI report, the at least one processor, individually or in any combination, is configured to:
multiplex the first parts of the one or more selected CSIs corresponding to the subset of the set of sub-configurations to form the incorporated first part for the one CSI report.

7. The apparatus of claim 6, wherein the one or more selected CSIs each further include a second part, the one CSI report further includes an incorporated second part, and wherein, to incorporate the one or more selected CSIs into the one CSI report, the at least one processor, individually or in any combination, is configured to:
multiplex the second parts of the one or more selected CSIs to form the incorporated second part for the one CSI report.

8. The apparatus of claim 2, wherein each selected CSI of the one or more selected CSIs respectively corresponds to one CSI report of the one or more CSI reports, and the one or more UCI bit sequences include a first UCI bit sequence, and wherein, to incorporate the one or more selected CSIs into the one or more CSI reports, the at least one processor, individually or in any combination, is further configured to:
multiplex the first parts of the one or more selected CSIs to form the first UCI bit sequence.

9. The apparatus of claim 8, wherein the one or more selected CSIs each further include a second part, and the one or more UCI bit sequences further include a second UCI bit sequence, and wherein, to incorporate the one or more selected CSIs into the one or more CSI reports, the at least one processor, individually or in any combination, is further configured to:
multiplex the second parts of the one or more selected CSIs to form the second UCI bit sequence.

10. The apparatus of claim 1, wherein, to incorporate the one or more selected CSIs into the one or more CSI reports, the at least one processor, individually or in any combination, is configured to:
incorporate the one or more selected CSIs into the one or more CSI reports based on an order indicator, wherein the order indicator includes a sequence of sub-configuration indices indicating an order for the corresponding sub-configurations.

11. The apparatus of claim 10, wherein the order for the corresponding sub-configurations is from a first sub-configuration index to a last sub-configuration index in the sequence of sub-configuration indices.

12. The apparatus of claim 10, wherein the order for the corresponding sub-configurations is from a last sub-configuration index to a first sub-configuration index in the sequence of sub-configuration indices.

13. The apparatus of claim 10, wherein the one or more CSI reports are aperiodic CSI (A-CSI) reports or semi-persistent CSI (SP-CSI) reports on a physical uplink shared channel (PUSCH), and wherein the at least one processor, individually or in any combination, is further configured to:
receive, from the network entity, downlink control information (DCI) activating a trigger state for the one or more CSI reports, wherein the trigger state includes the order indicator.

14. The apparatus of claim 10, wherein the one or more CSI reports are semi-persistent CSI (SP-CSI) reports on a physical uplink control channel (PUCCH), and wherein the at least one processor, individually or in any combination, is further configured to:
receive, from the network entity, a medium access control (MAC)-control element (MAC-CE) for the one or more CSI reports, wherein the MAC-CE includes the order indicator.

15. The apparatus of claim 10, wherein the one or more CSI reports are periodic CSI (P-CSI) reports, and the CSI report configuration includes the order indicator.

16. The apparatus of claim 10, wherein, to incorporate the one or more selected CSIs into the one or more CSI reports, the at least one processor, individually or in any combination, is configured to:
drop, based on the order indicator, one or more dropped CSIs to obtain the one or more selected CSIs.

17. The apparatus of claim 1, wherein, to transmit the one or more CSI reports, the at least one processor, individually or in any combination, is configured to:
transmit the one or more CSI reports according to a first report priority of the one or more CSI reports, wherein the first report priority is based on a first number of sub-configurations in the subset of sub-configurations.

18. The apparatus of claim 17, wherein the first report priority of the one or more CSI reports with more than one sub-configuration in the subset of sub-configurations is equal to a second report priority for a second CSI report with one sub-configuration in the subset of sub-configurations or a third report priority for a regular CSI not involving a sub-configuration.

19. The apparatus of claim 17, wherein the first report priority of the one or more CSI reports with more than one sub-configuration in the subset of sub-configurations is higher than a second report priority for a second CSI report with one sub-configuration in the subset of sub-configurations or a third report priority for a regular CSI not involving a sub-configuration.

20. The apparatus of claim 17, wherein the first report priority of the one or more CSI reports with more than one sub-configuration in the subset of sub-configurations is lower than a second report priority for a second CSI report with one sub-configuration in the subset of sub-configurations or a third report priority for a regular CSI not involving a sub-configuration.

21. An apparatus of wireless communication for a network entity, comprising:
at least one memory; and
at least one processor coupled to the at least one memory and, based at least in part on information stored in the at least one memory, the at least one processor, individually or in any combination, is configured to:
transmit, to a user equipment (UE), a channel state information (CSI) report configuration comprising a set of sub-configurations, wherein each sub-configuration in the set of sub-configurations corresponds to a transmission setting associated with a channel state information reference signal (CSI-RS); and
receive, from the UE, one or more CSI reports comprising one or more selected CSIs corresponding to a subset of the set of sub-configurations.

22. The apparatus of claim 21, further comprising a transceiver coupled to the at least one processor, wherein, to transmit the CSI report configuration, the at least one processor, individually or in any combination, is configured to transmit the CSI report configuration via the transceiver, and wherein the one or more selected CSIs each include a first part, and wherein, to receive the one or more CSI reports, the at least one processor, individually or in any combination, is configured to:
receive, from the UE, one or more uplink control information (UCI) bit sequences comprising the one or more CSI reports.

23. The apparatus of claim 22, wherein, to receive the one or more CSI reports, the at least one processor, individually or in any combination, is configured to:
receive one CSI report comprising the one or more selected CSIs corresponding to the subset of the set of sub-configurations, wherein the one CSI report includes an incorporated first part based on:
a concatenation of the first parts of the one or more selected CSIs corresponding to the subset of the set of sub-configurations, or
a multiplexing of the first parts of the one or more selected CSIs corresponding to the subset of the set of sub-configurations.

24. The apparatus of claim 21, wherein the one or more selected CSIs corresponding to the subset of the set of sub-configurations in the one or more CSI reports are based on an order indicator, wherein the order indicator includes a sequence of sub-configuration indices indicating an order for the corresponding sub-configurations.

25. The apparatus of claim 24, wherein the order for the corresponding sub-configurations is one of:
from a first sub-configuration index to a last sub-configuration index in the sequence of sub-configuration indices, or
from the last sub-configuration index to the first sub-configuration index in the sequence of sub-configuration indices.

26. The apparatus of claim 25, wherein the one or more CSI reports are aperiodic CSI (A-CSI) reports or semi-persistent CSI (SP-CSI) reports on a physical uplink shared channel (PUSCH), and wherein the at least one processor, individually or in any combination, is further configured to cause the network entity to:
transmit, to the UE, downlink control information (DCI) activating a trigger state for the one or more CSI reports, wherein the trigger state includes the order indicator.

27. The apparatus of claim 25, wherein the one or more CSI reports are semi-persistent CSI (SP-CSI) reports on a physical uplink control channel (PUCCH), and wherein the at least one processor, individually or in any combination, is further configured to cause the network entity to:
transmit, to the UE, a medium access control (MAC)-control element (MAC-CE) for the one or more CSI reports, wherein the MAC-CE includes the order indicator.

28. The apparatus of claim 25, wherein the one or more CSI reports are periodic CSI (P-CSI) reports, and wherein the CSI report configuration includes the order indicator.

29. A method of wireless communication at a user equipment (UE), comprising:
receiving, from a network entity, a channel state information (CSI) report configuration comprising a set of sub-configurations, wherein each sub-configuration in the set of sub-configurations corresponds to a transmission setting associated with a channel state information reference signal (CSI-RS);
determining one or more selected CSIs corresponding to a subset of the set of sub-configurations;
incorporating the one or more selected CSIs into one or more CSI reports; and
transmitting, to the network entity, the one or more CSI reports based on the incorporation.

30. A method of wireless communication at a network entity, comprising:
transmitting, to a user equipment (UE), a channel state information (CSI) report configuration comprising a set of sub-configurations, wherein each sub-configuration in the set of sub-configurations corresponds to a transmission setting associated with a channel state information reference signal (CSI-RS); and
receiving, from the UE, one or more CSI reports comprising one or more selected CSIs corresponding to a subset of the set of sub-configurations.
